(19) United States
(12) Patent Application Publication
(10) Pub. No.: US 2012/0093344 A1
(43) Pub. Date: Apr. 19, 2012

(54) OPTIMAL MODAL BEAMFORMER FOR SENSOR ARRAYS

(75) Inventors: Haohai Sun, Trondheim (NO); Shefeng Yan, Beijing (CN); U. Peter Svensson, Hundhamaren (NO)

(73) Assignee: NTNU TECHNOLOGY TRANSFER AS, Trondheim (NO)

(21) Appl. No.: 13/263,461

(22) PCT Filed: Apr. 9, 2010
(86) PCT No.: PCT/GB2010/000730

§ 371 Date: Jan. 3, 2012

(30) Foreign Application Priority Data
Apr. 9, 2009 (GB) 0906269.6

(51) Int. Cl. H04R 3/00; H04B 1/02

(52) U.S. Cl. 381/122; 367/138

(57) ABSTRACT

A method of forming a beampattern in a beamformer of the type in which the beamformer receives input signals from a sensor array, decomposes the input signals into the spherical harmonics domain, applies weighting coefficients to the spherical harmonics and combines them to form an output signal, wherein the weighting coefficients are optimized for a given set of input parameters by convex optimization. Formulations are provided for forming second order cone programming constraints for multiple main lobe generation, uniform and non-uniform side lobe control, automatic null steering, robustness and white noise gain.

The present invention relates to beamforming.

Beamforming is a technique for combining the inputs from several sensors in an array. Each sensor in the array generates a different signal depending on its location, these signals being representative of the overall scene. By combining these signals in different ways, e.g. by applying a different weighting factor or a different filter to each received signal, different aspects of the scene can be highlighted and/or suppressed. In particular, the directivity of the array can be changed by increasing the weights corresponding to a particular direction, thus making the array more sensitive in a chosen direction.

Beamforming can be applied to both electromagnetic waves and sound waves and has been used, for example, in radar and sonar. The sensor arrays can take on virtually any size or shape, depending on the application and the wavelengths involved. In simple applications, a one-dimensional linear array may suffice. For more complex applications, arrays in two or three dimensions may be required. Recently, beamforming has been used in the fields of 3-dimensional (3-D) sound reception, sound field analysis for room acoustics, voice pick up in video and teleconferencing, direction of arrival estimation and noise control applications. For these applications, arrays of microphones in three dimensions are required to allow a full 3-D acoustic analysis.

Of the possible three dimensional array arrangements, spherical arrays are of particular interest as more flexible three dimensional beam pattern synthesis can be realized than with other standard array geometries, and array processing can be performed using the mathematical framework of the spherical harmonics domain. A spherical array typically takes the form of a sphere with sensors distributed over its surface. The most common implementations include the “rigid sphere” in which the sensors are arranged on a physical sphere surface, and the “open sphere” in which the surface is only notional, but the sensors are held in position on this notional surface by other means. Other configurations such as dual open spheres (sensors arranged on two concentric notional spherical surfaces, one inside the other), spherical shell arrays (sensors arranged in between two concentric notional spherical surfaces, i.e. within the shell defined by them), single open spheres with Cardioid Microphones, and hemispheres are also suitable implementations. All of these can be used for decomposition of the sound field into spherical harmonics.

For a given array (of e.g. microphones or hydrophones for acoustic applications or antennas for radio applications), the weights applied to each of the sensors in the array define a “beampattern” for the array. However, typically, when one or more parts of the array are weighted more heavily than others, the beampattern develops “lobes” which indicate areas of strong reception and good signal gain and “nulls” which indicate areas of weak reception where incident waves will be highly attenuated. The arrangement of lobes and nulls depends both on the weights applied to the sensors and to the physical arrangement of the sensors. However, typically, the beampattern will include a “main” lobe for the strongest signal receiving direction (i.e. the principle maximum of the pattern) and one or more “side” lobes for the secondary (and other order) maxima of the pattern. Nulls are formed between the lobes.

In acoustic applications, considering the analysis of an auditory scene, the problem can be likened to the cocktail party problem in which it is desired to listen to a particular source (e.g. a friend who is talking to you), while ignoring or blocking out sounds from particular interfering sources (e.g. another conversation going on next to you). At the same time, it is also desirable to ignore or block out the background noise of the party in general. Similarly, the beamforming problem in a microphone array is to focus the receiving power of the array onto the desired source(s) while minimising the influence of the interfering sources and the background noise.

These problems can be of particular importance in applications such as teleconferencing in which two rooms are communicatively linked via microphone arrays and loudspeakers, i.e. each room has a microphone array to pick up sounds for transmission as audio signals to the other room and loudspeakers to convert signals received from the other room into sound. At any given time in one of the rooms (the near end), there may be one or more speaking persons whose voices must be captured, interference sources which should ideally be blocked, such as the loudspeakers which generate the sound from the other side of the call (the far end) and background noise e.g. air conditioning noises or echoes and reverberation due to the speaking persons and/or the loudspeakers.

This problem is generally addressed by the process known as “beamsteering” in which the main lobe of the beam pattern is aimed in the direction of the signal of interest, while nulls in the beam pattern (also known as notches) are steered towards the direction(s) of interference signal(s) (“null steering”).

The side lobes generally represent regions of the beampattern which receive a stronger than desired signal, i.e. they are unwanted local maxima of the beampattern. Side lobes are unavoidable, but by suitable choice of the weighting coefficients, the size of the side lobes can be controlled.

It is also possible to create multiple main lobes in the beampattern when there is more than one signal direction of interest. Other aspects of the beampattern which it is desirable to control are the beamwidth of the main lobe(s), robustness, i.e. the ability of the system to stand up to abnormal or unexpected inputs, and array signal gain (i.e. the gain in signal-to-noise ratio (SNR)).

In most environments, the auditory scene is constantly changing. Signals of interest come and go, signals from interference sources come and go, signals can change direction and amplitude noise levels can increase. In these situations, the sensor array ideally needs to be able to adapt to the changing circumstances, for example, it may need to move the mainlobe of the beampattern to follow a moving signal of interest, or it may need to generate a new null to counteract a new source of interference. Similarly, if a source of interference disappears, the constraints of the system are altered and a better optimal solution may be possible. Therefore, in these circumstances the array needs to be adaptive, i.e. it needs to be able to re-evaluate the constraints and to re-solve the optimization problem to find a new optimal solution. Further, in circumstances where the auditory scene changes rapidly, such as teleconferencing, the beamformer ideally needs to operate in real time; with people starting and stopping speaking all the time, sources of interest and sources of interference are constantly changing in number and direction.

A number of studies have been conducted in this field. To give a few examples, Meyer and Elko [J. Meyer and G. Elko, “A highly scalable spherical microphone array based on an orthonormal decomposition of the soundfield,” in Proc. ICASSP, vol. 2, May 2002, pp. 1781-1784] presented the application and analysis of sound field spherical harmonics decomposition in a spherical microphone array beampattern design, which is symmetric around the look direction, and steerable in 3-D space without changing the shape of the beampattern. See also WO2006/110230. As an extension to these studies, Rafaely [B. Rafaely, “Phase-mode versus delay-and-sum spherical microphone array processing,” IEEE Signal Process. Lett., vol. 12, no. 10, pp. 713-716, October 2005] applied the commonly used delay-and-sum beampattern design method to a spherical microphone array, that is, applying array weights and compensating for the delays at the free field microphones due to a single plane wave. This approach results in high robustness, but at the cost of decreased directivity at lower frequencies. In another study, Rafaely et al also achieved sidelobe control for a given mainlobe width and array order, using a classical Dolph-Chebyshev pattern design approach, to improve the directional analysis of a sound field [B. Rafaely, A. Koretz, R. Winik, and M. Agmon, “Spherical microphone array beampattern design for improved room acoustics analysis,” in Proceedings of the International Symposium on Room Acoustics, September 2007, p. S42]. By imposing a white noise gain (WNG) constraint into beampattern synthesis, Li and Duraswami [Z. Y. Li and R. Duraiswami, “Flexible and optimal design of spherical microphone arrays for beamforming,” IEEE Trans. Audio Speech Lang. Process., vol. 15, no. 2, pp. 702-714, February 2007], presented array weights optimization methods to find the balance between beamforming directivity and robustness, which is useful in practical applications. While the studies mentioned above considered only symmetrical beam patterns, Rafaely [B. Rafaely, “Spherical microphone array with multiple nulls for analysis of directional room impulse responses,” in Proc. ICASSP, April 2008, pp. 281-284] extended the beampattern design methods to non-symmetric cases for a spherical microphone array. This approach was formulated in both the space domain and the spherical harmonics domains, and included a multiple null-steering method, in which fixed nulls in the beampattern were formed and steered to the interferences coming from known outside beam directions, in order to achieve better signal to noise ratio.

In “Modal Analysis Based Beamforming for Nearfield or Farfield Speaker Localization in Robotics”, Argentieri et al, Proceedings of the 2006 IEEE/RSJ International Conference on Intelligent Robots and Systems, pp 866-871, convex optimization techniques were employed and a spherical harmonics framework was used to analyse the problem, but the wavefield was not decomposed into spherical harmonics.

In the above studies of spherical harmonics domain beamforming however, multiple deep nulls in the beampatterns could not be adaptively formed and steered to suppress the dynamic interferences coming from arbitrary outside beam directions. Such interference suppression is often desired in speech enhancement and multiple-channel acoustic echo cancellation for video or teleconference applications, and analysis for directional room impulse response (i.e. acoustic analysis of a room through impulse generation and reflection analysis). Additionally, the above studies were unable to effectively include multiple beamforming performance parameters, such as sidelobe control and robustness constraints into a single optimization algorithm, so it has not so far been possible to obtain the global optimum solution for all of these mutually correlated parameters.

The main difficulty is that optimization algorithms are computationally intensive. As the applications described above, e.g. teleconferencing, are consumer applications, the algorithm must be executable with readily available consumer computing power in a reasonable time. It must also be noted that these applications are based in real time and need to be adaptive in real time. It is therefore very difficult to optimize all of the desired parameters, while maintaining real time operation. The requirements for real time operation can vary depending upon the application of the array. However, in voice pick up applications like teleconferencing, the array has to be able to adapt at the same rate as the dynamics of the auditory scene change. As people tend to speak for periods of several seconds at a time, a beamformer which takes a few seconds (up to about 5 seconds) to re-optimize the beampattern is useful. However, it is preferred that the system be able to re-optimize the beampattern (i.e. recalculate the optimum weightings) in a time scale of the order of a second so as not to miss anything which has been said. Most preferably, the system should be able to re-optimize the weightings several times per second so that as soon as a new signal source (such as a new speaker) is detected, the beamformer ensures that an appropriate array gain is provided in that direction.

It should be noted that, as computing power is still increasing exponentially according to Moores' Law, advances in computing power will rapidly decrease the amount of time to perform the necessary calculations and in the future it is expected that real time applications will be carried out with a significantly increased rate of re-optimizing.

As there are several parameters which affect the choice of beam pattern in a given scenario, an optimal solution for one of these parameters will not necessarily be optimal for the others. Therefore a compromise has to be made between them. Finding the best (optimal) compromise between these factors depends on the requirements of the system. These can be formulated as constraints upon the optimization problem. For example, one might require the system to have a certain directivity or a gain above a chosen threshold level. Alternatively, one might require the sidelobe levels to be below a certain threshold or one might require that the system has a certain robustness. As discussed above, optimization is a computationally intensive process, and it becomes increasingly more intensive with every constraint added. Therefore, in practice it is normally unfeasible to apply more than a single constraint to the system if the optimal solution is to be found in a reasonable time.

In the studies performed so far, optimization algorithms have been limited to only one or two constraints. In some cases, the constraints have each been solved separately, one by one in individual stages, but it has not been possible to obtain a global optimum solution.

There remains a need to provide a method of finding a global optimum beampattern for a spherical array while applying multiple constraints to the system.

According to a first aspect of the invention, there is provided a method of forming a beampattern in a beamformer of the type in which the beamformer receives input signals from a sensor array, decomposes the input signals into the spherical harmonics domain, applies weighting coefficients to the spherical harmonics and combines them to form an output signal, wherein the weighting coefficients are optimized for a given set of input parameters by convex optimization.

By expressing the objective function and the constraints as convex functions, it becomes possible to apply the techniques of convex optimization. Convex optimization has the benefits of guaranteeing that a global minimum will be found if it exists, and that it can be found fast and efficiently using numerical methods.

In previous studies, in order to easily form a regular or irregular, and frequency independent beam pattern, array weight design approaches have always utilized the inversion of the mode amplitudes bₙ(ka) (discussed in more detail later) in the spherical harmonics domain to decouple frequency-dependent components. However, bₙ(ka) has small values at certain ka and n values, and its inversion may damage the robustness of the beamformer in practical implementations. In the present invention, by directly making the more general weights w*(k) the targets of the optimization framework, the optimization problem can be formulated as a convex optimization problem, i.e. one where the objective function and the constraints are all convex functions. The advantages of convex optimization, as discussed above, are that there are fast (i.e. computationally tractable) numerical solvers which can rapidly find the optimum values of the optimization variables. Further, as discussed above, convex optimization will always result in a global optimum solution rather than a local optimum solution. Thus, with the above formulation, the beamformer of the invention can adaptively optimize the array beampattern in real time even with the application of multiple constraints.

The technique of convex optimization has been known for a long time. Various numerical methods and software tools for solving convex optimization problems have also been known for some time. However, convex optimization can only be used when the objective function and the optimization constraints are all convex functions, that is a function ƒ is convex if ƒ(ax+by)≦aƒ(x)+bƒ(y) for all x, y, and all a, b, with a+b=1, a≧0 and b≧0. It is therefore not always possible to solve a given optimization problem using convex optimization techniques. First, the problem has to be formulated in a manner in which convex optimization can be applied. In other words, one has to take a property of the system which it is desired to minimise and formulate it as a convex function. Further all the constraints on the optimization problem must be formulated as either convex equalities/inequalities or linear equalities. By formulating the beamforming problem as a convex optimization problem, the present invention permits the use of a number of extremely efficient algorithms which make real time solution of multi-constraint beamforming problems computationally tractable.

Preferably, the sensor array is a spherical array in which the sensors' positions are located on a notional spherical surface. The symmetry of such an arrangement leads to simpler processing. A number of different spherical sensor array arrangements may be used with this invention. Preferably, the sensor array is of a form selected from the group of: an open sphere array, a rigid sphere array, a hemisphere array, a dual open sphere array, a spherical shell array, and a single open sphere array with cardioid microphones.

The array size can vary a great deal depending on the applications and the wavelengths involved. However, for microphone arrays used in voice pick up applications, the sensor array preferably has a largest dimension between about 8 cm and about 30 cm. In the case of a spherical array, the largest dimension is the diameter. A larger sphere has the benefit of handling low frequencies well, but to avoid spatial aliasing for high frequencies, the distance between two microphones should be smaller than half the wavelength of the highest frequency. Therefore if the microphone number is finite, the smaller sphere means a shorter distance between microphones and less spatial aliasing issue. It will be appreciated that in high frequency applications such as ultrasound imaging where frequencies of 5 to 100 MHz can be expected, the sensor array size will be significantly smaller. Similarly, in sonar applications, the array size may be significantly larger.

Preferably, the sensor array is an array of microphones. Microphone arrays can be used in numerous voice pick-up, teleconferencing and telepresence applications for isolating and selectively amplifying the voices of the different speakers from other interference noises and background noises. Although the examples described in this specification concern microphone arrays in the context of teleconferencing, it will be appreciated that the invention lies in the underlying technique of beamforming and is equally applicable in other audio fields such as music recording as well as in other fields such as sonar, e.g. underwater hydrophone arrays for location detection or communication, and radiofrequency applications such as radar with antennas for sensors.

In preferred embodiments, the optimization problem, and optionally also constraints, are formulated as one or more of: minimising the output power of the array, minimising the sidelobe level, minimising the distortion in the mainlobe region and maximising the white noise gain. One or more of these requirements can be selected as input parameters for the beamformer. Furthermore, any of the requirements can be formulated as the optimization problem. Any of the requirements can also be formulated as further constraints upon the optimization problem. For example, the problem can be formulated as minimising the output power of the array subject to minimising the sidelobe level or the problem can be formulated as minimising the sidelobe level subject to minimising the distortion in the mainlobe region. Several constraints may be applied if desired, depending upon the particular beamforming problem.

In some preferred embodiments, the optimization problem is formulated as minimising the output power of the array. This is the parameter which will be globally minimised subject to any constraints which are applied to the system. Thus, in the absence of constraints to the contrary in any given region (direction) of the beam pattern, the optimization algorithm aims to reduce the output power of the array gain in that region by reducing the array gain. This has the general benefit of minimising the gain as much as possible in all regions except those where gain is desired.

Preferably the input parameters include a requirement that the array gain in a specified direction be maintained at a given level, so as to form a main lobe in the beampattern. With the general tendency of the optimization algorithm to reduce gain as described above, a requirement that the gain be maintained at a given level in a specified direction ensures that a main lobe (i.e. a region of high gain and therefore signal amplification rather than signal attenuation) is present in the beampattern.

More preferably, the input parameters include requirements that the array gain in a plurality of specified directions be maintained at a given level, so as to form multiple main lobes in the beampattern. In other words, the directivity of the array is optimized by applying multiple constraints such that the gain of the array is maintained at a selected level in a plurality of directions. In this way multiple main lobes can be formed in the array's beampattern and multiple source signal directions can be provided with higher gain than the remaining directions.

Yet more preferably, individual required gain levels are provided for each of the plurality of specified directions, so as to form multiple main lobes of different levels in the beampattern. In other words, the optimization constraints are such as to apply different levels of signal maintenance (i.e. array gain) in different directions. For example, the array gain can be maintained at a higher or lower level in one direction than in other directions. In this way the beamformer can focus on multiple source signals, and at the same time equalise the levels of those signals. For example, if there were three source signals which it were desired to capture, with two of those signals being stronger than the third, the system can form three main lobes in the beampattern, with the lobe directed to the weaker signal having a stronger gain than the lobes directed to the stronger signals, thereby amplifying the weaker source more and equalising the signal strengths for the three sources.

Preferably the beamformer formulates the or each requirement as a convex constraint. More preferably, the beamformer formulates the or each requirement as a linear equality constraint. With the constraints formulated in this way, the problem becomes a second order cone programming problem which is a subset of convex optimization problems. The numerical solution of second order programming problems has been studied in detail and a number of fast and efficient algorithms are available for solving convex second order cone problems.

Preferably the beamformer formulates the or each main lobe requirement as a requirement that the array output for a unit magnitude plane wave incident on the array from the specified direction is equal to a predetermined constant. In other words, the beamforming pattern is constrained such that the array output will provide a specific gain for an incident plane wave from the specified direction. This form of constraint is a linear equality and thus can be applied to a second order cone programming problem as above.

In preferred embodiments of the invention, the input parameters include a requirement that the array gain in a specified direction is below a given level, so as to form a null in the beampattern. In other words, the beamformer optimization problem is subjected to an optimization constraint that the array gain in at least one direction is below a selected threshold. This enables minimization of the sidelobe region of the beampattern, thus restricting the size of the secondary maxima of the system. It also allows creation of “notches” in the beampattern, creating a particularly low gain in the selected direction(s) for blocking interference signals.

More preferably, the input parameters include requirements that the array gain in a plurality of specified directions is below a given level, so as to form multiple nulls in the beampattern. In other words, the beamformer optimization problem is subjected to optimization constraints that the array gain in a plurality of directions is below a corresponding threshold. In this way, multiple nulls can be formed in the beampattern, thereby allowing suppression of multiple interference sources.

Still more preferably, individual maximum gain levels are provided for each of the plurality of specified directions, so as to form multiple nulls of different depths in the beampattern. In this way, different levels of constraint can be applied to different regions of the beam pattern. For example, the side lobes can be kept generally below a certain level, but with more stringent constraints being applied in regions where notches or nulls are desired for blocking interference signals. By applying the most stringent constraints only where they are required, the freedom of the beampattern is affected less, allowing the remainder of the pattern to minimise more uniformly.

Preferably, the beamformer formulates the or each side lobe requirement as a convex constraint. More preferably, the beamformer formulates the or each side lobe requirement as a second order cone constraint. As above, with the constraints formulated in this way, the problem becomes a second order cone programming problem which is a subset of convex optimization problems. The numerical solution of second order programming problems has been studied in detail and a number of fast and efficient algorithms are available for solving convex second order cone problems.

Most preferably, the beamformer formulates the or each side lobe requirement as a requirement that the magnitude of the array output for a unit magnitude plane wave incident on the array from the specified direction is less than a predetermined constant. As above, this form of constraint is a convex inequality and thus can be applied to a second order cone programming problem as above.

Preferably, the input parameters include a requirement that the beampattern has a specified level of robustness. In applications where it is vital that the desired source signal be picked up, it is desirable to ensure that the system does not fail merely due to minor mis-alignments, random noise or other unexpected interference. In other words, it is desired that the system be resilient to errors to a certain extent. Preferably, the level of robustness is specified as a limitation on a norm of a vector comprising the weighting coefficients. More preferably, the norm is the Euclidean norm. As described in more detail below, minimising the norm of the weighting coefficients vector maximises the white noise gain of the array and thus increases the robustness of the system.

Preferably, the weighting coefficients are optimized by second order cone programming. As described above, second order cone programming is a subset of convex optimization techniques which has been studied in much detail and fast and efficient algorithms are available for solving such problems rapidly. Such numerical algorithms can converge on the global minimum of the problem very quickly, even when numerous constraints are applied on the system.

Preferably one or more weighting coefficients are optimized for each order n of spherical harmonic, but within each order of spherical harmonics, said weighting coefficients are common to all degrees m=−n to m=n of said order n. By reducing the number of weighting coefficients in this manner, the beampattern is confined to being rotationally symmetric about the look direction. However, such a beampattern is useful in a number of circumstances and the reduction in the number of coefficients simplifies the optimization problem and allows for faster computation of the solution.

In some preferred embodiments the input signals may be transformed into the frequency domain before being decomposed into the spherical harmonics domain. In some preferred embodiments the beamformer may be a broadband beamformer in which the frequency domain signals are divided into narrowband frequency bins and wherein each bin is optimized and weighted separately before the frequency bins are recombined into a broadband output. In other preferred embodiments, the input signals may be processed in the time domain and the weighting coefficients may be the tap weights of finite impulse response filters applied to the spherical harmonic signals.

The choice of processing domain will depend on the circumstances of the particular scenario, i.e. the particular beam forming problem. For example, the expected frequency spectrum to be received and processed may influence the choice between the time domain and the frequency domain, with one domain giving a better solution or being computationally more efficient.

Processing in the time domain is particularly advantageous in some instances because it is inherently broadband in nature. Therefore, with such an implementation, there is no need to perform a computationally intensive fourier transform into the frequency domain before optimization and a corresponding computationally intensive inverse fourier transform back to the time domain after optimization. It also avoids the need to split the input into a number of narrowband frequency bins in order to obtain a broadband solution. Instead a single optimization problem may be solved for all weighting coefficients. In some embodiments, the weighting coefficients will take the form of finite impulse response (FIR) filter tap weights.

In principle, from the viewpoint of beamforming performance, the time domain and the frequency domain implementations can give the same beamforming performance if the FIR length equals the FFT length. The time domain may have a significant advantage over the frequency domain in some real implementations since no FFT and inverse FFT will be needed. However from the viewpoint of optimization complexity, assuming that the FIR and FFT have the same length L, the computational complexity of optimizing a set of FIRs (i.e. L FIR coefficients for each channel) by a single optimization, would be much higher than that of optimizing a set of array weights (i.e. a single weight for each channel) by L sub-band optimizations. Therefore, each approach may have advantages in different situations. According to a second aspect, the present invention provides a beamformer comprising: an array of sensors, each of which is arranged to generate a signal; a spherical harmonic decomposer which is arranged to decompose the input signals into the spherical harmonics domain and to output the decomposed signals; a weighting coefficients calculator which is arranged to calculate weighting coefficients to be applied to the decomposed signals by convex optimization based on a set of input parameters; and an output generator which combines the decomposed signals with the calculated weighting coefficients into an output signal.

Such a beamformer implements all the benefits of the beamforming method described above. Moreover, all of the preferred features described above in relation to the beamforming method also apply to this implementation of the beamformer. As discussed above, in the time domain implementation, the output generator may comprise a number of finite impulse response filters.

Preferably, the beamformer further comprises a signal tracker which is arranged to evaluate the signals from the sensors to determine the directions of desired signal sources and the directions of unwanted interference sources. Such algorithms can run in parallel with the beamforming optimization algorithms, using the same data. While the localization algorithms pick out the directions of signals of interest and the directions of sources of interference, the beamformer forms an appropriate beampattern for amplifying the source signals and attenuating the interference signals.

As described above, this description is predominantly concerned with signal processing in the spherical harmonics domain. However, the techniques described herein are also applicable to the other domains, particularly the space domain. Although convex optimization has been used in some applications in space domain processing, it is believed to be a further inventive concept to formulate the problem for a spherical array. Therefore, according to a further aspect of the invention, there is provided a method of forming a beampattern in a beamformer for a spherical sensor array of the type in which the beamformer receives input signals from the array, applies weighting coefficients to the signals and combines them to form an output, wherein the weighting coefficients are optimized for a given set of input parameters by convex optimization. The inventors have recognised that the techniques and formulations developed in relation to the spherical harmonics domain, also apply to processing of a spherical array in the space domain and that it is therefore also possible, with this invention, to carry out multiple constraint optimization in real time in the space domain.

According to a further aspect, the invention provides a method of forming a beampattern in a beamformer of the type in which the beamformer receives input signals from a sensor array, applies weighting coefficients to the signals and combines them to form an output signal, wherein the weighting coefficients are optimized for a given set of input parameters by convex optimization, subject to constraints that the array gain in a plurality of specified directions be maintained at a given level, so as to form multiple main lobes in the beampattern, and wherein each requirement is formulated as a requirement that the array output for a unit magnitude plane wave incident on the array from the specified direction is equal to a predetermined constant.

As discussed above, the applicability of the methods derived in this description allow multiple constraints to be applied to the optimization problem without slowing the system up so much that it is of little practical use. Therefore, with the techniques and formulations of this invention, it is possible to apply multiple-main lobe formation and directivity constraints at the same time as applying multiple null forming and steering constraints, robustness constraints, and main-lobe beam-width constraints.

Preferably the beamformer is capable of operating in real time or quasi-real time. It will be appreciated that if the environment (e.g. the acoustic environment in audio applications) is fixed, it is not necessary to update the array weights during run time. Instead, a single set of optimized weights can be calculated in advance (e.g. at system startup or upon a calibration instruction) and need not be changed during operation. However, this set up does not make use of the full power of the invention. Preferably therefore, the array dynamically changes the optimum weights by re-solving the optimization problem according to the changing environment and constraints. As described above, the system can preferably re-optimize the array weights in real time or quasi-real time. The definition of real time may vary from application to application. However, in this description we mean that the array is capable of re-optimizing the array weights and forming a new optimized beam pattern in under a second. By quasi-real time, we mean an optimization time of up to about 5 seconds. Such quasi-real time may still be useful in situations where the dynamics of the environment do not change so rapidly, e.g. acoustics in a lecture where the number and direction of sources and interferences change only infrequently.

In real time or quasi-real time operation, the optimization operations preferably run in the background in order to gradually and continuously update the weights. Alternatively, sets of weights for certain situations can be pre-calculated and stored in memory. The most appropriate set of weights can then be simply loaded into the system upon a change in environment. However, it will be appreciated that this implementation does not make full use of the power and speed of this invention for actual optimization in real time.

The beamformer of the present invention can operate well in the space domain as well as in the spherical harmonics domain. The choice of domain will depend on the particular application of the array, the geometry of the array, the characteristics of the signals that it is expected to handle and the type of processing which is required of it. Although the space domain and the spherical harmonics domain are generally the most useful, other domains (e.g. the cylindrical harmonics domain) may also be used. In addition, the processing can be done in the frequency domain or the time domain. In particular, time domain processing with spherical harmonic decomposition is also useful. Preferably therefore the sensor signals are decomposed into a set of orthogonal basis functions for further processing. Most preferably, the orthogonal basis functions are the spherical harmonics, i.e. the solutions to the wave equation in spherical co-ordinates, and the wave field decomposition is performed by a spherical Fourier transform. The spherical harmonics domain is particularly well suited to spherical or near spherical arrays.

According to a further aspect, the present invention provides a method of optimizing a beampattern in a beamformer in a sensor array in which the input signals from the sensors are weighted and combined to form an array output signal, and wherein the sensor weights are optimized by expressing the array output power as a convex function of the sensor weights and minimizing the output power subject to one or more constraints, wherein the one or more constraints are expressed as equalities and/or inequalities of convex functions of the sensor weights.

It can be seen that the method of the present invention provides a general solution to the beamforming problem. A large number of constraints can be applied simultaneously in a single optimization problem, with one global optimum solution. However, if fewer constraints are applied, the results of the previous studies described above can be replicated. The present invention can therefore be seen as a more general solution to the problem.

A more detailed analysis of preferred forms of the system will now be discussed.

Since spatial over-sampling is typically employed in practice, the following analysis concentrates on spherical harmonics domain processing, which tends to be more efficient. However, it will be appreciated that the techniques discussed in relation to the spherical harmonic domain weighting functions applies in the same manner to an analysis in the space domain and results in an analogous convex optimization problem.

A few derivations of background material and useful results are given in the Annex to this application. The equation numbers in the following description follow on from those of the annex.

From previous studies, in order to easily form a regular or irregular, and frequency independent beam pattern, array weight design approaches have always utilized the inversion of bₙ(ka) in the spherical harmonics domain to decouple frequency-dependent components. However, as bₙ(ka) has small values at certain ka and n values, and its inversion will damage the robustness in practical implementations, we directly make the more general weights w*(k) the targets of our optimization framework.

This next section develops the results derived in the annex, using matrix formulations and derives the convex optimization problem and the corresponding constraints of the invention.

We use the notation

x=vec({[xₙₘ]ₘ₌₋ₙⁿ}ₙ₌₀^{N})=[x₀₀, . . . , xₙₘ, . . . , x_{NN}]^{T}, (16)

where vec(·) denotes stacking all the entries in the parentheses to obtain an (N+1)²×1 column vector and (·)^{T} denotes the transpose.

Using this notation, we can further define

w=vec({[wₙₘ]ₘ₌₋ₙⁿ}ₙ₌₀^{N}), (17)

b=vec({[bₙ]ₘ₌ₙⁿ}ₙ₌₀^{N}), (18)

Y=vec({[Yₙ^{m}]ₘ₌₋ₙⁿ}ₙ₌₀^{N}), (19)

p=vec({[pₙₘ]ₘ₌₋ₙⁿ}ₙ₌₀^{N}). (20)

Note that (18) means that b has repetitions of bₙ from the (n²+1) through (n+1)² entries. From (9), it is seen that p can be viewed as the modal array manifold vector.

We can write (14) in vector notation as

y(ka)=w^{H}(k)x(ka)=x^{H}(ka)w(k), (21)

where (·)^{H} denotes the Hermitian transpose.

In the following description, the optimization problem is formulated as minimizing the array output power in order to suppress any interferences coming from outside beam directions, while the signal from the mainlobe direction is maintained and the sidelobes are controlled. Furthermore, for the purpose of improving the beamformer's robustness, a white noise gain constraint is also applied to limit the norm of array weights to a specified constant.

The array output power is given by

P₀(ω)=E[y(ka)y*(ka)]=w^{H}(k)E[x(ka)x^{H}(ka)]w=w^{H}(k)R(ω)w(k), (22)

where E[·] denotes the statistical expectation of the quantity in the brackets, and R(ω) is the covariance matrix (spectral matrix) of x.

The directivity pattern, denoted by H(ka,Ω), is a function of the array's response to a unit input signal from all angles of interest. Thus,

$$\begin{matrix}H ( ka , Ω ) = {\sum }_{s = 1}^{M} {α}_{s} p ( ka , Ω , {Ω}_{s} ) {w}^{*} ( k , {Ω}_{s} ) \\ = {\sum }_{n = 0}^{N} {\sum }_{m = - n}^{n} {p}_{nm} ( ka , Ω ) {w}_{nm}^{*} ( k ) \\ = {w}^{H} ( k ) p ( ka , Ω ) .\end{matrix} \qquad ( 23 )$$

Assuming that the signal sources are uncorrelated from each other, the covariance matrix of x has the following form

$$\begin{matrix}R ( ω ) = E [ x ( ka ) {x}^{H} ( ka ) ] \\ = {β}^{2} {σ}_{0}^{2} p ( ka , {Ω}_{0} ) {p}^{H} ( ka , {Ω}_{0} ) + \\ {\sum }_{d = 1}^{D} {σ}_{d}^{2} p ( ka , {Ω}_{d} ) {p}^{H} ( ka , {Ω}_{d} ) + Q ( ω ) ,\end{matrix} \qquad ( 24 )$$

where {σ_{d}²}_{d=0}^{D} are the powers of the D+1 uncorrelated signals, and Q(ω)=E[N(ω)N^{H}(ω)] is the noise covariance matrix with N=vec({[Nₙₘ]ₘ₌₋ₙⁿ}ₙ₌₀^{N}).

We now consider a special case of noise field: isotropic noise, i.e., noise distributed uniformly over a sphere. Isotropic noise with power spectral density σₙ²(ω) can be viewed as if there are an infinite number of uncorrelated plane waves arriving at the sphere from all directions Ω with uniform power density σₙ²(ω)/(4π). Thus, by integrating the covariance matrix over all directions, the isotropic noise covariance matrix is given by

$${Q}_{iso} ( ω ) = \frac{{σ}_{n}^{2} ( ω )}{4 π} {\int }_{Ω ∈ {S}^{2}} p ( ka , Ω ) {p}^{H} ( ka , Ω ) d Ω , \qquad ( 25 )$$

Using (7), (18) and (19), (25) can be rewritten as

$$\begin{matrix}{Q}_{iso} ( ω ) = \frac{{σ}_{n}^{2} ( ω )}{4 π} {\int }_{Ω ∈ {S}^{2}} {[ b ( ka ) \cdot Y ( Ω ) ] [ b ( ka ) \cdot Y ( Ω ) ]}^{H} d Ω \\ = \frac{{σ}_{n}^{2} ( ω )}{4 π} diag \{ b ( ka ) \cdot {b}^{*} ( ka ) \} \\ = \frac{{σ}_{n}^{2} ( ω )}{4 π} diag \{ \begin{matrix}{\vert {b}_{0} ( ka ) \vert}^{2} , {\vert {b}_{1} ( ka ) \vert}^{2} , {\vert {b}_{1} ( ka ) \vert}^{2} , \\ {\vert {b}_{1} ( ka ) \vert}^{2} , … , {\vert {b}_{N} ( ka ) \vert}^{2} ,\end{matrix} \} ,\end{matrix} \qquad ( 26 )$$

where ∘ denotes the Hadamard (i.e. element-wise) product of two vectors. Note that the spherical harmonic orthonormal property (4) has been employed in the above derivation.

In practical applications, the exact covariance matrix R(ω) is unavailable. Therefore, the sample covariance matrix is usually used instead of Eq. (24). The sample covariance matrix is given by:

$$\hat{R} ( ω ) = \frac{1}{I} {\sum }_{i = 1}^{I} x ( ka , i ) {x}^{H} ( ka , i )$$

where I is the number of snapshots.

The array gain G(k) is defined to be the ratio of the signal-to-noise ratio (SNR) at the output of the array to the SNR at an input sensor.

$$G ( k ) = \frac{{σ}_{0}^{2} {\vert {w}^{H} ( k ) p ( ka , {Ω}_{0} ) \vert}^{2}}{{w}^{H} ( k ) Q ( ω ) w ( k )} / \frac{{σ}_{0}^{2}}{{σ}_{n}^{2}} = \frac{{\vert {w}^{H} ( k ) p ( ka , {Ω}_{0} ) \vert}^{2}}{{w}^{H} ( k ) p ( ω ) w ( k )} , \qquad ( 27 )$$

where ρ(ω)=Q(ω)/σₙ²(ω) is the normalized noise covariance matrix.

A common measure of performance of an array is the directivity. The directivity factor D(k), or directive gain, can be interpreted as the array gain against isotropic noise. Replacing Q in (27) by Qᵢₛₒ gives the directivity factor

$$\begin{matrix}D ( k ) = \frac{{σ}_{n}^{2} ( ω ) \vert {w}^{H} ( k ) {p ( ka , {Ω}_{0} \vert}^{2}}{{w}^{H} ( k ) {Q}_{iso} ( ω ) w ( k )} \\ = \frac{4 π {\vert {\sum }_{n = 0}^{N} {\sum }_{m = - n}^{n} {p}_{nm} ( ka , Ω ) {w}_{nm}^{*} ( k ) \vert}^{2}}{{\sum }_{n = 0}^{N} {\vert {b}_{n} ( ka ) \vert}^{2} {\sum }_{m = - n}^{n} {\vert {w}_{nm} ( k ) \vert}^{2}} .\end{matrix} \qquad ( 28 )$$

The directivity index (DI) is then defined as DI(k)=10 log₁₀ D(k) dB.

There are many performance measures by which one may assess the capabilities of a beamformer. Commonly used array performance measures are directivity, array gain, beamwidth, sidelobe level, and robustness.

The trade-off among these conflicting performance measures represents the beamformer design optimization problem. In the method of this invention, the optimization problem is directed to minimizing the output power subject to a distortionless constraint on the signal of interest (SOI) (i.e. to form the main lobe in the beampattern) together with any number of other desired constraints, such as sidelobes and robustness constraints. Taking the array weights vector w(k) as the optimization variable, the multi-constraint beamforming optimization problem may be formulated as

$${min}_{w} {w}^{H} ( k ) R ( ω ) w ( k ) , \\ subject to H ( ka , {Ω}_{0} ) = 4 π / M , \\ \vert H ( ka , Ω ) \vert \leq ɛ \cdot 4 π / M , ∀ Ω ∈ {Ω}_{SL} , \\ W N G ( k ) \geq ζ ( k ) , \qquad ( 29 )$$

where Ω_{SL} is the sidelobe region, and ε and ζ are user parameters to control the sidelobes and the white noise gain (i.e., array gain against white noise) WNG, respectively. A white noise gain constraint has been commonly used to improve the robustness of a beamformer. The look direction (i.e. the direction of the main lobe) is Ω₀, the SOI's direction of arrival.

The white noise gain (WNG) is given by

$$W N G ( k ) = \frac{1}{{\sum }_{s = 1}^{M} {\vert w ( k , {Ω}_{s} ) \vert}^{2}} . \qquad ( 30 )$$

Using (15), WNG can be rewritten as

$$W N G ( k ) = \frac{1}{{\sum }_{s = 1}^{M} \vert {w ( k , {Ω}_{s} \vert}^{2}} = \frac{4 π / M}{{\sum }_{n = 0}^{N} {\sum }_{m = - n}^{n} {\vert {w}_{nm} ( k ) \vert}^{2}} = \frac{4 π / M}{{w}^{H} ( k ) w ( k )} . \qquad ( 31 )$$

It is seen that the white noise gain is inversely proportional to the norm of the weight vector. In order to improve the beamformer's robustness, the denominator, or norm of array weights may be limited to a certain threshold.

Due to the correlation between responses at neighbouring directions, the sidelobe region Ω_{SL} can be approximated using a finite number of grid points in direction, Ωₗ ∈ Θ_{SL}, l=1, . . . L. The choice of L is determined by the required accuracy of approximation.

Using (23) and (31), (29) now takes the form

$${min}_{w} {w}^{H} ( k ) R ( ω ) w ( k ) , \\ subject to {w}^{H} ( k ) p ( ka , {Ω}_{0} ) = 4 π / M , \\ \vert {w}^{H} ( k ) p ( ka , {Ω}_{l} ) \vert \leq ɛ \cdot 4 π / M , {Ω}_{l} ∈ {Θ}_{SL} , l = 1 , … , L , \\ ‖ w ( k ) ‖ \leq \sqrt{\frac{4 π}{M ζ ( k )}} . \qquad ( 32 )$$

where ∥·∥ denotes the Euclidean norm.

Second Order Cone Programming is a subclass of the general convex programming problems where a linear function is minimized subject to a set of second-order cone constraints and possibly a set of linear equality constraints. The problem can be described as

$${min}_{y} {b}^{T} y , \\ subject to ‖ {A}_{i} y + {b}_{i} ‖ \leq {c}_{i}^{T} y + {d}_{i} , i = 1 , 2 , … , I , \\ Fy = g ,$$

where b∈C^{α×1},y∈C^{α×1},Aᵢ∈C^{(α}^{ᵢ}^{-1)×α},bᵢ∈C^{(α}^{ᵢ}^{-1)×1},cᵢ∈C^{α×1},cᵢ^{T}y∈ [symbol] ,dᵢ∈ [symbol] ,F∈C^{g×α},g∈C^{g×1} with [symbol] and C being the set of real and complex numbers (or matrices) respectively.

Taking the optimization problem defined in (32) above, and omitting the arguments ω and k temporarily for convenience, let

R=U^{H}U (32.1)

be the Cholesky factorization of R. We obtain

w^{H}Rw=(Uw)^{H}(Uw)=∥Uw∥² (32.2)

Introducing a new scalar non-negative variable y₁, and defining y=[y₁,w^{T}]^{T} and b=[1,0^{T}]^{T}, where 0 is the vector of zeros of a conformable dimension, the optimization problem (32) can be rewritten as

$${min}_{y} {b}^{T} y \\ subject to [ \begin{matrix}0 & {p}^{H} ( ka , {Ω}_{0} )\end{matrix} ] y = 4 π / M , \\ ‖ [ 0 U ] y ‖ \leq [ 1 {0}^{T} ] y , \\ \vert [ \begin{matrix}0 & {p}^{H} ( ka , {Ω}_{l} )\end{matrix} ] y \vert \leq ɛ \cdot 4 π / M , \\ {Ω}_{l} ∈ {Θ}_{SL} , l = 1 , … , L , \\ ‖ [ \begin{matrix}0 & I\end{matrix} ] y ‖ \leq \sqrt{\frac{4 π}{M ζ ( k )}} , \qquad ( 32.3 )$$

where I is an identity matrix. Thus, the optimization problem (32) has been rewritten in the form of Second Order Cone Programming problem. Numerical methods can therefore be used to find the solution to this problem efficiently. After solving the optimization problem, the only parameters of interest in the vector of variables y are given by its subvector w.

It can therefore be seen that this optimization problem has been formulated as a convex second-order cone programming (SOCP) problem where a linear function is minimized subject to a set of second-order cone constraints and possibly a set of linear equality constraints. This is a subclass of the more general convex programming problems. SOCP problems are computationally tractable and can be solved efficiently using known numerical solvers. An example of such a numerical solver is the SeDuMi solver (http://sedumi.ie.lehigh.edu/) available for MATLAB. The global optimal numerical solution of an SOCP problem is guaranteed if it exists, i.e. if a global minimum exists for the problem, the numerical solving algorithm will find it. Further, as the techniques are highly computationally tractable, many constraints can be included in the optimization problem while maintaining a real-time optimization. SOCP is more efficient in computation than general convex optimization and so it is highly preferred for real time applications.

Concerning computational complexity, when interior-point methods are used to solve the SOCP problem derived in (32.3) above, the number of iterations to decrease the duality gap to a constant fraction of itself is bounded above by O(\sqrt{l+1}) (here the term “l” is due to the equality constraint), and the amount of computation per iteration is O[α²(Σᵢαᵢ+g)]. For the optimization problem (32.2), the amount of computation per iteration is O{[(N+1)²+1]²[1+((N+1)²+1)+2L+((N+1)²+1)]}=O{[(N+1)²+1]²[3+2(N+1)²+2L]} and the number of iterations is O(\sqrt{L+3}). The algorithm converges typically in less than 10 iterations (a well-known and widely accepted fact in the optimization community).

Before going on to describe preferred embodiments of the invention, it should be noted that the above analysis is all based on the assumption that the signal sources are in the far-field, so that they may be approximated by plane waves incident on the array.

It should also be noted that the analysis is based on a narrowband beamformer design. The broadband beamformer can be simply realized by decomposing the frequency band into narrower frequency bins and processing each bin with the narrowband beamformer.

If implemented in the time domain, then in order to achieve a broadband beamformer, the proper time delays and weights are applied to each of the sensors for each sub-band, in order to form the beampattern, or, alternatively an FIR-and-weight method can be used to achieve broadband beamforming in the time domain. However, if implemented in the frequency domain, then for each narrow frequency bin, complex weights are applied to each of the sensors. The above description focuses on the frequency domain implementation and optimizes the complex weights for each frequency. A more detailed description of a time domain implementation follows.

The above approach bases the signal model in the frequency domain, where the complex-valued modal transformation and array processing are employed. In order to achieve a broadband beamformer, which is very important for speech and audio applications, the broadband array signals are decomposed into narrower frequency bins using the discrete Fourier transform (DFT), then each frequency bin is independently processed using the narrowband beamforming algorithm, and then an inverse DFT is employed to synthesise the broadband output signal. Since the frequency-domain implementation is performed with block processing, it might be unsuitable for time-critical speech and audio applications due to its associated time delay.

It is well known that, in classical element space array processing, the broadband beamformer can be implemented in the time domain using the filter-and-sum structure in which a bank of finite impulse response (FIR) filter are placed at the output of sensors, and the filter outputs are summed together to produce the final output time series. The main advantage of the time-domain filter-and-sum implementation is that the beamformer can be updated at run time when each new snapshot arrives. The key point of the filter-and-sum beamformer design is how to calculate the FIR filters' tap weights, in order to achieve the desired beamforming performance.

The spherical array modal beamforming can also be implemented in the time domain with the real-valued modal transformation and the filter-and-sum beamforming structure. WO 03/061336 proposed a novel time domain implementation structure for spherical array modal beamformer, within the spherical harmonics framework. In that implementation, the number of the signal processing channels is reduced significantly, the real and imaginary parts of spherical harmonics are employed as the spherical Fourier transform basis to convert the time domain broadband signals to the real-valued spherical harmonics domain, and the look direction of the beamformer can be tactfully decoupled from its beampattern shape. To achieve a frequency independent beampattern, WO 03/061336 proposed to employ inverse filters to decouple the frequency-dependent components in each signal channel, however, such kind of inverse filtering could damage the system robustness (J. Meyer and G. Elko, “ A highly scalable spherical microphone array based on an orthonormal decomposition of the soundfield”, in Proc. ICASSP, vol. 2, May 2002, pp. 1781-1784.). Moreover, since no systematic performance analysis framework has been formulated for such a filter-and-sum modal beamforming structure, all the mutually conflicting broadband beamforming performance measures, such as directivity factor, sidelobe level, and robustness, etc. cannot be effectively controlled.

Here, a broadband modal beamforming framework implemented in the time domain is presented. This technique is based on a modified filter-and-sum modal beamforming structure. We derive the expression for the array response, the beamformer output power against both isotropic noise and spatially white noise, and the mainlobe spatial response variation (MSRV) in terms of the FIR filters tap weights. With the aim of achieving a suitable trade-off among multiple conflicting performance measures (e.g., directivity index, robustness, sidelobe level, mainlobe response variation, etc.), we formulate the FIR filters' tap weights design problem as a multiply-constrained optimization problem which is computationally tractable.

In addition, in the arrangement described here, a steering unit is described. With the steering unit, the number of signal processing channels is reduced, and the modal beamforming approach is computationally more efficient compared to a classical element space array processing. The steering unit reduces the computational complexity by forming a beam pattern which is rotationally symmetric about the look direction. Although not as general as the asymmetric beam pattern discussed above, such a configuration is still frequently useful. It will be appreciated however that the steering unit is not an essential component of the time domain beamformer discussed below and it can be omitted if the more general beam pattern formation is desired.

In the following, we will reformulate some of the results previously derived for the frequency domain approach and add in a beam steering unit. We assume that the time series received at the sth microphone is xₛ(t) and the frequency-domain notation is x(ƒ,Ωₛ). The discrete spherical Fourier transform (spherical Fourier coefficients) of x(ƒ,Ωₛ), is given by

$${x}_{nm} ( f ) = {\sum }_{s = 1}^{M} {α}_{s} {x ( f , {Ω}_{s} ) [ {Y}_{n}^{m} ( {Ω}_{s} ) ]}^{*} . \qquad ( T5 )$$

Using (T5), the sound field is transformed from the time or frequency domain into the spherical harmonics domain.

We assume each microphone has a weighting, denoted by w*(ƒ,Ωₛ). The array output, denoted by y(ƒ), can be calculated as:

$$y ( f ) = {\sum }_{s = 1}^{M} {α}_{s} x ( f , {Ω}_{s} ) {w}^{*} ( f , {Ω}_{s} ) = {\sum }_{n = 0}^{N} {\sum }_{m = - n}^{n} {x}_{nm} ( f ) {w}_{nm}^{*} ( f ) , \qquad ( T6 )$$

where w*ₘₙ(ƒ) are the spherical Fourier coefficients of w*(ƒ,Ωₛ). The second summation term in (T6) can be viewed as weighting in the spherical harmonics domain.

As before, we use the notation

x_{b}=vec({[x_{bm}]ₘ₌₋ₙⁿ}ₙ₌₀^{N})=[x₀₀, . . . , xₙₘ, . . . , x_{NN}]^{T}, (T7)

where vec(·) denotes stacking all the entries in the parentheses to obtain an (N+1)²×1 column vector and (·)^{T} denotes the transpose.

We can rewrite (T6) in vector notation as

y(ƒ)=w_{b}^{H}(ƒ)x_{b}(ƒ), (T8)

where w_{b}=vec({[wₙₘ]ₘ₌₋ₙⁿ}ₙ₌₀^{N}).

The array output power is given by

Pₒᵤₜ(ω)=E[y(ƒ)y*(ƒ)]=w_{b}^{H}(ƒ)E[x_{b}(ƒ)x_{b}^{H}(ƒ)]w_{b}=w_{b}^{H}(ƒ)R_{b}(ƒ)w_{b}(ƒ), (T9)

where E[·] denotes the statistical expectation of the quantity in the brackets, R_{b}(ƒ) is the covariance matrix (spectral matrix) of x_{b}.

The directivity pattern, denoted by B(ƒ,Ω), is a function of the array's response to a unit input signal from all angles of interest Ω. Thus,

$$\begin{matrix}B ( f , Ω ) = {\sum }_{s = 1}^{M} {α}_{s} p ( ka , Ω , {Ω}_{s} ) {w}^{*} ( f , {Ω}_{s} ) \\ = {\sum }_{n = 0}^{N} {\sum }_{m = - n}^{n} {p}_{nm} ( ka , Ω ) {w}_{nm}^{*} ( f ) .\end{matrix} \qquad ( T10 )$$

By applying Parseval's relation for the spherical Fourier transform to the weights, we have

$${\sum }_{s = 1}^{M} {α}_{s} {\vert w ( f , {Ω}_{s} ) \vert}^{2} = {\sum }_{n = 0}^{N} {\sum }_{m = - n}^{n} {\vert {w}_{nm} ( f ) \vert}^{2} . \qquad ( T11 )$$

Intuitively, we want the microphones distributed uniformly on the spherical surface. However, true equidistant spatial sampling is only possible for arrangements that are constructed according to five regular polyhedrons geometries, i.e., tetrahedron, cube, octahedron, dodecahedron, and icosahedron. An arrangement that provides a close-to-uniform sampling scheme has been used, in which 32 microphones are located at the center of the faces of a truncated icosahedron. Another example of specific, simple, close-to-uniform grid shown to behave well with spherical array is Fliege grid. In these close-to-uniform cases, αₛ≅4π/M.

In order to form a beampattern with rotational symmetry around the look direction Ω₀, the array weights take the form

$${w}_{nm}^{*} ( f ) = \sqrt{\frac{4 π}{2 n + 1}} {c}_{n} ( f ) {Y}_{n}^{m} ( {Ω}_{0} ) . \\ where \\ \sqrt{\frac{4 π}{2 n + 1}} {Y}_{n}^{m} ( {Ω}_{0} ) \qquad ( T12 )$$

act as the steering units that are responsible for steering the look direction by Ω₀ and cₙ(ƒ) act as pattern generation.

Using (T12) in (T6) gives

$$y ( f ) = {\sum }_{n = 0}^{N} [ \sqrt{\frac{4 π}{2 n + 1}} {\sum }_{m = - n}^{n} {x}_{nm} ( f ) {Y}_{n}^{m} ( {Ω}_{0} ) ] {c}_{n} ( f ) . \qquad ( T13 )$$

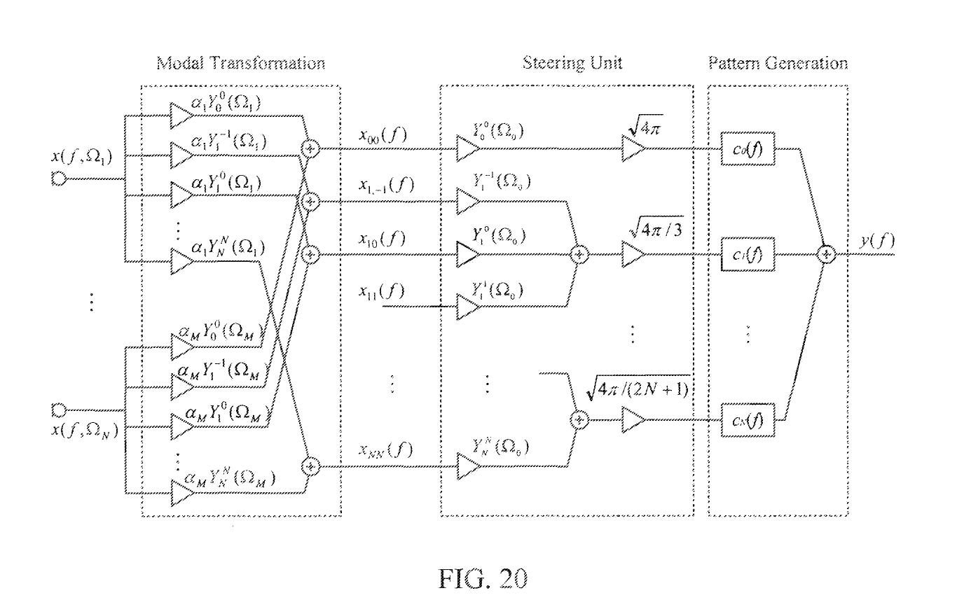

According to (T5) and (T13), we get the modal beamformer structure as depicted in FIG. 20. First, the sound field data x(ƒ,Ωₛ)are transformed from the time or frequency domain into the spherical harmonics domain data xₙₘ(ƒ). Then, the harmonics domain data xₙₘ(ƒ) are directly fed to the modal beamformer (steering, weighting, and summing) This is a difference to that presented by Meyer and Elko in “A highly scalable spherical microphone array based on an orthonormal decomposition of the soundfield” in Proc. ICASSP, vol. 2, May 2002, pp. 1781-1784, where the spherical harmonics, which have been compensated for bₙ, are fed to a modal beamformer instead. This modification is presented to avoid a bad robustness of the beamformer caused by the compensation unit.

Using (T12), (5) and (7) in (T10) gives

$$\begin{matrix}B ( f , Ω ) = {\sum }_{n = 0}^{N} {\sum }_{m = - n}^{n} {p}_{nm} ( ka , Ω ) {w}_{nm}^{*} ( f ) \\ = {\sum }_{n = 0}^{N} {\tilde{c}}_{n} ( f ) {b}_{n} ( ka ) {\sum }_{m = - n}^{n} {[ {Y}_{n}^{m} ( Ω ) ]}^{*} {Y}_{n}^{m} ( {Ω}_{0} ) \\ = {\sum }_{n = 0}^{N} {\tilde{c}}_{n} ( f ) {b}_{n} ( ka ) \frac{2 n + 1}{4 π} {P}_{n} ( cos Θ ) \\ = {\sum }_{n = 0}^{N} {c}_{n} ( f ) {b}_{n} ( ka ) \sqrt{\frac{2 n + 1}{4 π}} {P}_{n} ( cos Θ ) ,\end{matrix} \qquad ( T14 )$$

where Pₙ is the Legendre polynomial and Θ is the angle between Ω and Ω₀.

The robustness is an important measure of array performance and is commonly quantified by the white noise gain (WNG), i.e., array gain against white noise. Using (T11) and assuming that αₛ≅4π/M, WNG is given by

$$\begin{matrix}W N G ( f ) = \frac{1}{{\sum }_{s = 1}^{M} {\vert w ( f , {Ω}_{s} ) \vert}^{2}} \\ ≅ \frac{4 π / M}{{\sum }_{n = 0}^{N} {\sum }_{m = - n}^{n} {\vert {w}_{nm} ( f ) \vert}^{2}} \\ = \frac{4 π / M}{{\sum }_{n = 0}^{N} \frac{4 π}{2 n + 1} {c}_{n}^{*} ( f ) {c}_{n} ( f ) {\sum }_{m = - n}^{n} {{Y}_{n}^{m} ( {Ω}_{0} ) [ {Y}_{n}^{m} ( {Ω}_{0} ) ]}^{*}} \\ = \frac{4 π / M}{{\sum }_{n = 0}^{N} {c}_{n}^{*} ( f ) {c}_{n} ( f )} \\ = \frac{4 π / M}{{c}^{H} ( f ) c ( f )} ,\end{matrix} \qquad ( T15 )$$

where c=[c₀, . . . , cₙ, . . . , c_{N}]^{T} is an (N+1)×1 column vector.

For the Maximum-DI modal beamformer and the Maximum-WNG modal beamformer, we have

$$\begin{matrix}{[ {c}_{n} ( f ) ]}_{MDI} = \frac{4 π \sqrt{4 π ( 2 n + 1 )}}{{M ( N + 1 )}^{2} {b}_{n} ( ka )} , & ( T16 ) \\ {[ {c}_{n} ( f ) ]}_{MWNG} = \sqrt{\frac{4 π}{2 n + 1}} \frac{4 π {b}_{n}^{*} ( ka )}{M {\sum }_{n = 0}^{N} {\vert {b}_{n} ( ka ) \vert}^{2}} . & ( T17 )\end{matrix}$$

where the subscript MDI and MWNG denote the Maximum-DI beamformer and the Maximum-WNG beamformer, respectively.

Up to now, the mathematical analysis of the modal transformation and beamforming has been discussed for complex spherical harmonics. We next consider the time-domain implementation of the broadband modal beamformer. Since the real-valued coefficients are more suitable for a time-domain implementation, we can work with the real and imaginary parts of the spherical harmonics domain data.

We assume that the sampled broadband time series received at the sth microphone is xₛ(l)=xₛ(t)|_{t=IT}_{ₛ}, where Tₛ is the sampling interval. Considering that Yₙ^{m}(Ω) is independent of frequency, similar to (T5), the broadband spherical harmonics domain data is given

$${x}_{nm} ( l ) = {\sum }_{s = 1}^{M} {α}_{s} {{x}_{s} ( l ) [ {Y}_{n}^{m} ( {Ω}_{s} ) ]}^{*} , l = 1 , 2 , … \tilde{L} , \qquad ( T18 )$$

where xₙₘ(l) is the time-domain notation of xₙₘ(ƒ) in (T5), i.e., the inverse Fourier transform of xₙₘ(ƒ), and \tilde{L} is the length of the input data.

Filter-and-sum structure has been used in broadband beamforming in classical element space array processing, in which each sensor feeds an FIR filter and the filter outputs are summed to produce the beamformer output time series. Using the analogy to classical array processing, we can apply the filter-and-sum structure to a modal beamformer. That is, we place a bank of real-valued FIR filters at the output of the steering unit the filters act as the role of complex weighting cₙ(ƒ) in a broadband frequency band. An advantage of the modal beamformer with the steering unit is that it is computationally efficient since only N+1 FIR filters are required, in contrast to the classical element space beamformer, which requires Al filters. Note that M≧(N+1)². It should be noted that the steering unit is an optional feature of this invention and if it is not used, a FIR filter is used for each of the (N+1)² spherical harmonics (Yₙ^{m}(Ω)).

Let hₙ be the impulse response of the FIR filter corresponding to the spherical harmonics of order n, i.e., hₙ=[hₙ₁,hₙ₂, . . . , h_{nL}]^{T}, n=0, . . . , N. Here, L is the length of the FIR filter. Performing the inverse Fourier transform to (T13) and considering that the response of the filter hₙ over the working frequency band is approximately equal to cₙ(ƒ), the time-domain beamformer output, denoted by y(l)|ₗ₌₁^{\tilde{L}}, can be given by

$$y ( l ) {\vert}_{l = 1}^{\tilde{L}} = {\sum }_{n = 0}^{N} \{ {[ \sqrt{\frac{4 π}{2 n + 1}} {\sum }_{m = - n}^{n} ( {\sum }_{s = 1}^{M} {α}_{s} {{x}_{s} ( l ) [ {Y}_{n}^{m} ( {Ω}_{s} ) ]}^{*} ) {Y}_{n}^{m} ( {Ω}_{0} ) ]}_{l = 1}^{\tilde{L}} * {h}_{n} \} = {\sum }_{n = 0}^{N} \{ {x}_{n} ( l , {Ω}_{0} ) {\vert}_{l = 1}^{\tilde{L}} * {h}_{n} \} . \qquad ( T19 )$$

where * denotes the convolution and

$${x}_{n} ( l , {Ω}_{0} ) = \sqrt{\frac{4 π}{2 n + 1}} {\sum }_{m = - n}^{n} ( {\sum }_{s = 1}^{M} {α}_{s} {{x}_{s} ( l ) [ {Y}_{n}^{m} ( {Ω}_{s} ) ]}^{*} ) {Y}_{n}^{m} ( {Ω}_{0} ) = \sqrt{\frac{4 π}{2 n + 1}} \{ {\tilde{x}}_{n 0} ( l ) {Y}_{n}^{0} ( {Ω}_{0} ) + 2 {\sum }_{m = 1}^{n} {\tilde{x}}_{nm} ( l ) Re [ {Y}_{n}^{m} ( {Ω}_{0} ) ] + 2 {\sum }_{m = 1}^{n} {\breve{x}}_{nm} ( l ) Im [ {Y}_{n}^{m} ( {Ω}_{0} ) ] \} , \qquad ( T20 )$$

where Re(·) and Im(·) denote the real part and imaginary part, respectively,

$${\tilde{x}}_{nm} ( l ) = {\sum }_{s = 1}^{M} {α}_{s} {x}_{s} ( l ) Re [ {Y}_{n}^{m} ( {Ω}_{s} ) ] and$$

$${\breve{x}}_{nm} ( l ) = {\sum }_{s = 1}^{M} {α}_{s} {x}_{s} ( l ) Im [ {Y}_{n}^{m} ( {Ω}_{s} ) ] .$$

Note that the property Yₙ^{-m}(Ω)=(−1)^{m}[Yₙ^{m}(Ω)]* has been employed in the above derivation.

Using (3) in (T20) gives

$${x}_{n} ( , {Ω}_{0} ) = {\tilde{x}}_{n 0} ( l ) {P}_{n}^{0} ( cos {θ}_{0} ) + 2 {\sum }_{m - 1}^{n} \sqrt{\frac{( n - m ) !}{( n + m ) !}} {P}_{n}^{m} ( cos {θ}_{0} ) [ {\tilde{x}}_{nm} ( l ) cos ( m {φ}_{0} ) + {\breve{x}}_{nm} ( l ) sin ( m {φ}_{0} ) ] . \qquad ( T21 )$$

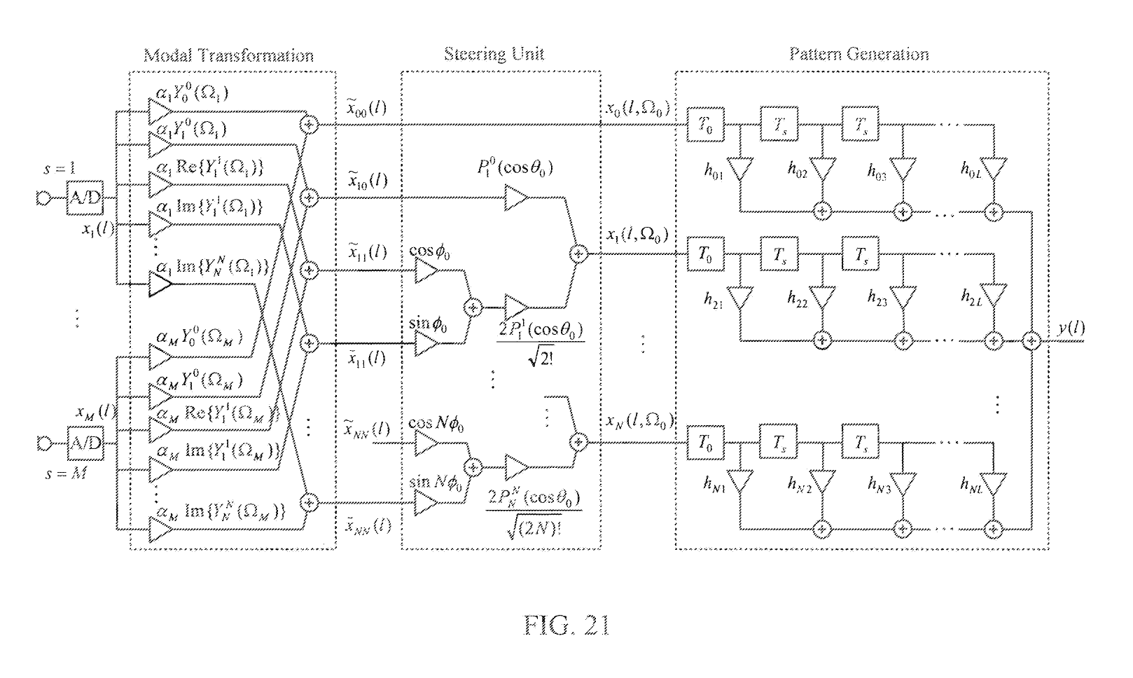

According to (T19) and (T21), the time-domain implementation of the broadband modal beamformer can be given in FIG. 21. Note that the predelay T₀ is attached before the FIR filters for each harmonics. This predelay is used to compensate the inherent group delay of a FIR filter, which is typically chosen as T₀=−(L−1)Tₛ/2. The aim is then to choose the impulse response (or tap weights) of these FIR filters to achieve the desired frequency-wavenumber response of the modal beamformer.

The complex frequency response of the FIR filter with impulse response hₙ is given by

$${H}_{n} ( f ) = {\sum }_{l = 1}^{L} {h}_{nl} {e}^{- j ( l - 1 ) 2 π {fT}_{s}} = {h}_{n}^{T} e ( f ) , \qquad ( T22 )$$

where e(ƒ)=[1,e^{-j2πƒT}^{ₛ}, . . . , e^{-j(L-1)2πƒT}^{ₛ}]^{T}.

Let η=e^{-j2πƒT}^{₀}. The total weighting function in the pattern generation unit corresponding to the nth order spherical harmonics at frequency f is given by

ĉₙ(ƒ)=ηhₙ^{T}e(ƒ), n=0,1, . . . , N. (T23)

We use ĉₙ(k) in (T23) in lie of cₙ(k) in (T14) to obtain

$$B ( f , Ω ) = {\sum }_{n = 0}^{N} {b}_{n} ( ka ) \sqrt{\frac{2 n + 1}{4 π}} {P}_{n} ( cos Θ ) η {h}_{n}^{T} e ( f ) . \\ Let {a}_{n} ( f , Θ ) = {b}_{n} ( ka ) \sqrt{\frac{2 n + 1}{4 π}} {P}_{n} ( cos Θ ) η , \qquad ( T24 )$$

a=[a₀, . . . , aₙ, . . . , a_{N}]^{T}, and define an (N+1)L×1 composite vector h=[h₀^{T},h₁^{T}, . . . , h_{N}^{T}]^{T}. Eq.(T24) can be rewritten as

$$\begin{matrix}B ( f , Ω ) = {\sum }_{n = 0}^{N} {a}_{n} ( f , Θ ) {h}_{n}^{T} e ( f ) \\ = {[ a ( f , Θ ) ⊗ e ( f ) ]}^{T} h \\ = {u}^{T} ( f , Θ ) h \\ = {h}^{T} u ( f , Θ ) ,\end{matrix} \qquad ( T25 )$$

where \textcircled{×} denotes the Kronecker product and u(ƒ,Θ)=a(ƒ,Θ)\textcircled{×}e(ƒ).

Note that, in the case of αₛ=4π/M, the array output amplitude in (T6) is the factor 4π/M higher than the classical array processing, which is

$${\sum }_{s = 1}^{M} x ( f , {Ω}_{s} ) {w}^{*} ( f , {Ω}_{s} ) .$$

Therefore, the distortionless constraint in the spherical harmonics domain becomes

h^{T}u(ƒ,0)=4π/M. (T26)

We now consider a special case of noise field: spherically isotropic noise, i.e., noise distributed uniformly over a sphere. Isotropic noise with power spectral density σₙ²(ƒ) can be viewed as if there are an infinite number of uncorrelated plane waves arriving at the sphere from all directions Ω with uniform power density σₙ²(ƒ)/(4π). Thus, by integrating the covariance matrix over all directions, the isotropic noise covariance matrix is given by

$$\begin{matrix}\begin{matrix}{Q}_{biso} ( f ) = \frac{{σ}_{n}^{2} ( f )}{4 π} {\int }_{Ω ∈ {S}^{2}} {p}_{b} ( ka , Ω ) {p}_{b}^{H} ( ka , Ω ) d Ω , \\ = \frac{{σ}_{n}^{2} ( f )}{4 π} {\int }_{Ω ∈ {S}^{2}} {[ \begin{matrix}{b}_{b} ( ka ) \cdot \\ {Y}_{b}^{*} ( Ω )\end{matrix} ] [ \begin{matrix}{b}_{b} ( ka ) \cdot \\ {Y}_{b}^{*} ( Ω )\end{matrix} ]}^{H} d Ω \\ = \frac{{σ}_{n}^{2} ( f )}{4 π} diag \{ {b}_{b} ( ka ) \cdot {b}_{b}^{*} ( ka ) \}\end{matrix} & ( T27 ) \\ = \frac{{σ}_{n}^{2} ( f )}{4 π} diag \{ \begin{matrix}{\vert {b}_{0} ( ka ) \vert}^{2} , {\vert {b}_{1} ( ka ) \vert}^{2} , {\vert {b}_{1} ( ka ) \vert}^{2} , \\ {\vert {b}_{1} ( ka ) \vert}^{2} , … , {\vert {b}_{N} ( ka ) \vert}^{2}\end{matrix} \} , & ( T28 )\end{matrix}$$

where p_{b}=vec({[pₙₘ]ₘ₌₋ₙⁿ}ₙ₌₀^{N}), b_{b}=vec({[bₙ]ₘ₌₋ₙⁿ}ₙ₌₀^{N}), Y_{b}=vec({[Yₙ^{m}]ₘ₌₋ₙⁿ}ₙ₌₀^{N}), ∘ denotes the Hadamard (i.e., element-wise) product of two vectors, and diag{·} denotes a square matrix with the elements of its arguments on the diagonal. Note that the spherical harmonic orthonormal property has been employed in the above derivation.

Consider a special case with only isotropic noise impinging on the microphone array. We use (T9) with R_{b}(ƒ) replaced by the isotropic noise covariance matrix Q_{biso}(ƒ) to obtain the isotropic noise-only beamformer output power, denoted by Pᵢₛₒₒᵤₜ(ω),

$$\begin{matrix}\begin{matrix}{P}_{isoout} ( f ) = {w}_{b}^{H} ( f ) {Q}_{biso} ( f ) {w}_{b} ( f ) \\ = {\sum }_{n = 0}^{N} {\sum }_{m = - n}^{n} {w}_{nm}^{*} ( f ) \frac{{σ}_{n}^{2} ( f ) {\vert {b}_{n} ( ka ) \vert}^{2}}{4 π} {w}_{nm} ( f ) \\ = {\sum }_{n = 0}^{N} \frac{{σ}_{n}^{2} ( f ) {\vert {b}_{n} ( ka ) \vert}^{2}}{2 n + 1} {c}_{n} ( f ) {c}_{n}^{*} ( f ) \\ {\sum }_{m = - n}^{n} {{Y}_{n}^{m} ( {Ω}_{0} ) [ {Y}_{n}^{m} ( {Ω}_{0} ) ]}^{*} \\ = {\sum }_{n = 0}^{N} {c}_{n} ( f ) \frac{{σ}_{n}^{2} ( f ) {\vert {b}_{n} ( ka ) \vert}^{2}}{4 π} {c}_{n}^{*} ( f ) \\ = {c}^{T} ( f ) {Q}_{ciso} ( f ) {c}^{*} ( f ) ,\end{matrix} \\ where & ( T29 ) \\ \begin{matrix}{Q}_{ciso} ( f ) = \frac{{σ}_{n}^{2} ( f )}{4 π} diag \{ \begin{matrix}{\vert {b}_{0} ( ka ) \vert}^{2} , {\vert {b}_{1} ( ka ) \vert}^{2} , \\ {\vert {b}_{2} ( ka ) \vert}^{2} , … , {\vert {b}_{N} ( ka ) \vert}^{2}\end{matrix} \} \\ = \frac{{σ}_{n}^{2} ( f )}{4 π} diag \{ {b}_{c} ( ka ) \cdot {b}_{c}^{*} ( ka ) \}\end{matrix} & ( T30 )\end{matrix}$$

with b_{c}(ka)=[b₀(ka),b₁(ka),b₂(ka), . . . , b_{N}(ka)]^{T}.

Using (T23) and denoting ĉ=[ĉ₀, . . . , ĉₙ, . . . , ĉ_{N}]^{T} gives

ĉ(ƒ)=[ηh₀^{T}e(ƒ), . . . , ηhₙ^{T}e(ƒ), . . . , ηh_{N}^{T}e(ƒ)]T=η[I_{(N-1)×(N+1)}\textcircled{×}e(ƒ)]^{T}h. (T31)

Using ĉ(k) in lie of c(k) in (T29) gives

$$\begin{matrix}{P}_{isoout} ( f ) = {c}^{T} ( f ) {Q}_{ciso} ( f ) {c}^{*} ( f ) \\ = {h}^{T} [ {I}_{( N + 1 ) \times ( N + 1 )} ⊗ e ( f ) ] {{Q}_{ciso} ( f ) [ {I}_{( N + 1 ) \times ( N + 1 )} ⊗ e ( f ) ]}^{H} h \\ = {h}^{T} {Q}_{hiso} ( f ) h .\end{matrix} \qquad ( T32 )$$

where Qₕᵢₛₒ(ƒ)=[I_{(N+1)×(N+1)}\textcircled{×}e(ƒ)]Q_{ciso}(ƒ)[I_{(N+1)×(N+1)}\textcircled{×}e(ƒ)]^{H} is the isotropic noise covariance matrix associated with h.

For a broadband isotropic noise that occupy the frequency band [ƒ_{L}, ƒ_{U}] with ƒ_{L} and ƒ_{U} being respectively the lower and upper bound frequency, its broadband covariance matrix, denoted by Q̅ₕᵢₛₒ, can be given by performing the integration with respect to ƒ over the region [f_{L},f_{U}]

Q̅ₕᵢₛₒ=∫_{ƒ}_{_{L}}^{ƒ}^{_{U}}Qₕᵢₛₒ(ƒ). (T33)

where the integration can be approximated by performing summation.

Assume that the spatially white noise has a flat spectrum σₙ²(ƒ)=1 over the frequency band [ƒ_{L},ƒ_{U}]. The broadband isotropic noise-only beamformer output power is

P̅ᵢₛₒₒᵤₜ=h^{T} Q̅ₕᵢₛₒh. (T34)

Consider another special case with only spatially white noise with power spectral density σₙ²(ƒ) impinging on the microphone array. In the case of αₛ≅4π/M, the spatially white noise-only beamformer output power, denoted by P_{wout}(f), is given by

$$\begin{matrix}{P}_{wout} ( f ) = {σ}_{n}^{2} ( f ) {( \frac{4 π}{M} )}^{2} {\sum }_{s = 1}^{M} {\vert w ( f , {Ω}_{s} ) \vert}^{2} \\ ≅ \frac{4 {πσ}_{n}^{2} ( f )}{M} {\sum }_{n = 0}^{N} {\sum }_{m = - n}^{n} {\vert {w}_{nm} ( f ) \vert}^{2} \\ = \frac{4 {πσ}_{n}^{2} ( f )}{M} {\sum }_{n = 0}^{N} {\hat{c}}_{n}^{*} ( f ) {\hat{c}}_{n} ( f ) \\ = \frac{4 {πσ}_{n}^{2} ( f )}{M} {\sum }_{n = 0}^{N} {\vert {h}_{n}^{T} e ( f ) \vert}^{2} .\end{matrix} \qquad ( T35 )$$

Assume that the spatially white noise has a flat spectrum σₙ²(ƒ)=1 over the whole frequency band [0,fₛ/2]. The broadband beamformer output power, denoted by P̅_{wout}, is given by

$$\begin{matrix}{\overline{P}}_{wout} = {\int }_{0}^{{f}_{s} / 2} {P}_{wout} ( f ) \\ = {\int }_{0}^{{f}_{s} / 2} \frac{4 π}{M} {\sum }_{n = 0}^{N} {\vert {h}_{n}^{T} e ( f ) \vert}^{2} \\ = \frac{4 π}{M} {\sum }_{n = 0}^{N} {\int }_{0}^{{f}_{s} / 2} {\vert {h}_{n}^{T} e ( f ) \vert}^{2} \\ = \frac{4 π}{M} {\sum }_{n = 0}^{N} {h}_{n}^{T} {h}_{n} \\ = \frac{4 π}{M} {h}^{T} h .\end{matrix} \qquad ( T36 )$$

The broadband white noise gain, denoted by BWNG, is then defined as

$$B W N G = \frac{{( 4 π / M )}^{2}}{{\overline{P}}_{wout}} = \frac{4 π / M}{{h}^{T} h} . \qquad ( T37 )$$

A common measure of performance of an array is the directivity. The directivity factor D(ƒ), or directive gain, can be interpreted as the array gain against isotropic noise, which is given by

$$D ( f ) = \frac{{σ}_{n}^{2} ( f ) {( 4 π / M )}^{2}}{{h}^{T} {Q}_{hiso} ( f ) h} . \qquad ( T38 )$$

Frequently, we express the directivity factor in dB and refer to it as the directivity index (DI), DI(ƒ)=10lg D(ƒ), where lg(·)=log₁₀(·).

The mainlobe spatial response variation (MSRV), is defined as

γ_{MSRV}(ƒ,θ)=|h^{T}u(ƒ,Θ)−h^{T}u(ƒ₀,Θ)|, (T39)

where ƒ₀ is a chosen reference frequency.

Let ƒₖ ∈[ƒ_{L},ƒ_{U}] (k=1,2, . . . , K), Θⱼ ∈Θ_{ML} (j=1, . . . , N_{ML}) , and Θᵢ ∈Θ_{SL} (i=1, . . . , N_{SL}) be a chosen (uniform or nonuniform) grid that approximates the frequency band [ƒ_{L},ƒ_{U}], the mainlobe region Θ_{ML}, and the sidelobe region Θ_{SL}, respectively. We define an N_{ML}K×1 column vector γ_{MSRV} and an N_{SL}K×1 column vector B_{SL}, whose entries are respectively given by

[γ_{MSRV}]_{k+(j-1)K}=γ_{MSRV}(ƒₖ,Θⱼ), (T40)

[B_{SL}]_{k+(i-1)K}=B(ƒₖ,Θᵢ). (T41)

Then, the norm of γ_{MSRV}, i.e., ∥γ_{MSRV}∥_{q}, can be used as a measure of the frequency-invariant approximation of the synthesized broadband beampatterns over frequencies. The subscript q ∈ {2, ∞} stands for the l₂ (Euclidean) and l_{∞} (Chebyshev) norm, respectively. Similarly, ∥B_{SL}∥_{q} is a measure of sidelobe behavior.

There are many performance measures by which one may assess the capabilities of a beamformer. Commonly used array performance measures are directivity, MSRV, sidelobe level, and robustness. The trade-off among these conflicting performance measures represents the beamformer design optimization problem. After formulating the broadband spherical harmonics domain beampattern B(ƒ,Ω) (T25), the broadband isotropic noise-only beamformer output power P̅ᵢₛₒₒᵤₜ (T34), the broadband white noise gain BWNG (T37), the mainlobe spatial response variation vector γ_{MSRV} (T⁴⁰), and the sidelobe behavior vector B_{SL} (T41), the optimal array pattern synthesis problem for broadband modal beamformer can be formulated as

$${min}_{h} {μ}_{l} , l = \{ 1 , 2 , 3 , 4 \} , \\ subject to B ( {f}_{k} , {Ω}_{0} ) = 4 π / M , k = 1 , 2 , … , K \\ {\overline{P}}_{isoout} \leq {μ}_{1} , {‖ {γ}_{MSRV} ‖}_{{q}_{1}} \leq {μ}_{2} , {‖ {B}_{SL} ‖}_{{q}_{2}} \leq {μ}_{3} , {BWNG}^{- 1} \leq {μ}_{4} , \qquad ( T42 )$$

where q₁,q₂ ∈ {2,∞}, and {μₗ}ₗ₌₁⁴ include a cost function and three user parameters. In a similar manner to the frequency domain problem discussed above, the optimization problem (T42) can be seen to be in a convex form and can be formulated as a so-called Second Order Cone Program (SOCP) which can be solved efficiently using an SOCP solver such as SeDuMi.

(T42) is given as a general expression which can be used to formulate an appropriate optimization problem depending on the beamforming objectives. For example, any of the four functions (l=1, 2, 3, 4) can be used as the target function with any of the remaining functions used as further constraints. With l=1, the problem is formulated as minimising the output power of the array. With l=2, the problem is minimising the distortion in the mainlobe region. With l=3, the problem is minimising the sidelobe level and with l=4, the problem is maximising the white noise gain (robustness). In each case, the problem can be formulated subject to any or all of the other constraints, e.g. the problem can be formulated with l=2 as the objective function and with l=1, l=3 and l=4 as further constraints upon the problem. It can therefore be seen that this beamformer can be made extremely flexible.

In this arrangement, the filter tap weights are optimized for a given set of input parameters by convex optimization. The input signals from the sensor array are decomposed into the spherical harmonics domain and then the decomposed spherical harmonic components are weighted by the FIR tap weights before being combined to form the output signal.

It should be noted that, although this description provides examples which are mostly concerned with telephone conferencing, the invention is in no way restricted to telephone conferencing applications. Rather the invention lies in the beamforming method which is equally applicable to other technological fields. These include ambisonics for high end surround sound systems and music recording systems where it may be desired to emphasise or de-emphasise particular regions of a very complex auditory scene. For such applications, the multi-main lobe directionality and level control and the simultaneous option of multiple side lobe constraints of the present invention are especially applicable.

Similarly, the beamformer of the present invention can also be applied to frequencies significantly higher or lower than voice band applications. For example, sonar systems with hydrophone arrays for communication and for localization tend to operate at lower frequencies, whereas ultrasound applications, with an array of ultrasound transducers operating typically in the frequency range of 5 to 30 MHz will also benefit from the beamformer of the present invention. Ultrasound beamforming can be used for example in medical imaging and tomography applications where rapid multiple selective directionality and interference suppression can lead to higher image quality. Ultrasound benefits greatly from real time speeds where imaging of patients is affected by constant movement from breathing and heartbeats as well as involuntary movements.

The present invention is also not limited to the analysis of longitudinal sound waves. Beam forming applies equally to electromagnetic radiation where the sensors are antennas. In particular, in radio frequency applications, radar systems can benefit greatly from beamforming It will be appreciated that these systems also require real time adaptation of the beampattern for example when tracking several aircraft, each of which moves it considerable speed, multi-main lobe forming in real time is highly beneficial.

Further, applications of the present invention include seismic exploration, e.g. for petroleum detection. In this field, it is essential to have a very specific and accurate look direction. Therefore, the ability to apply main lobe width and directionality constraints fast allows faster operation of such systems where large amounts of ground have to be covered.

In one preferred embodiment therefore, the invention comprises a beamformer as described above, wherein the sensor array is an array of hydrophones.

In another preferred embodiment, the invention comprises a beamformer as described above, wherein the sensor array is an array of ultrasound transducers.

In another preferred embodiment, the invention comprises a beamformer as described above, wherein the sensor array is an array of antennas. In some preferred embodiments the antennas are radiofrequency antennas

It will be appreciated that the beamformer of the present invention is largely implemented in software and the software is executed on a computing device (which may be for example a general personal computer (PC) or a mainframe computer, or it may be a specially designed and programmed ROM (Read Only Memory) or it may be implemented in Field Programmable Gate Arrays (FPGAs). On such devices, software may be pre-loaded or it may be transferred onto the system via a data carrier or via transfer over a network. Systems which are connected to a Wide Area Network such as the Internet, may be arranged to download new versions of the software and updates to it.

Therefore, viewed from a further aspect, the present invention provides a software product which when executed on a computer cause the computer to carry out the steps of the above described method(s). The software product may be a data carrier. Alternatively, the software product may comprise signals transmitted from a remote location.

Viewed from another aspect, the invention provides a method of manufacturing a software product which is in the form of a physical carrier, comprising storing on the data carrier instructions which when executed by a computer cause the computer to carry out the method(s) described above.

Viewed from yet another aspect the invention provides a method of providing a software product to a remote location by means of transmitting data to a computer at that remote location, the data comprising instructions which when executed by the computer cause the computer to carry out the method(s) described above.

Preferred embodiments of the invention will now be described, by way of example only, and with reference to the accompanying drawings in which:

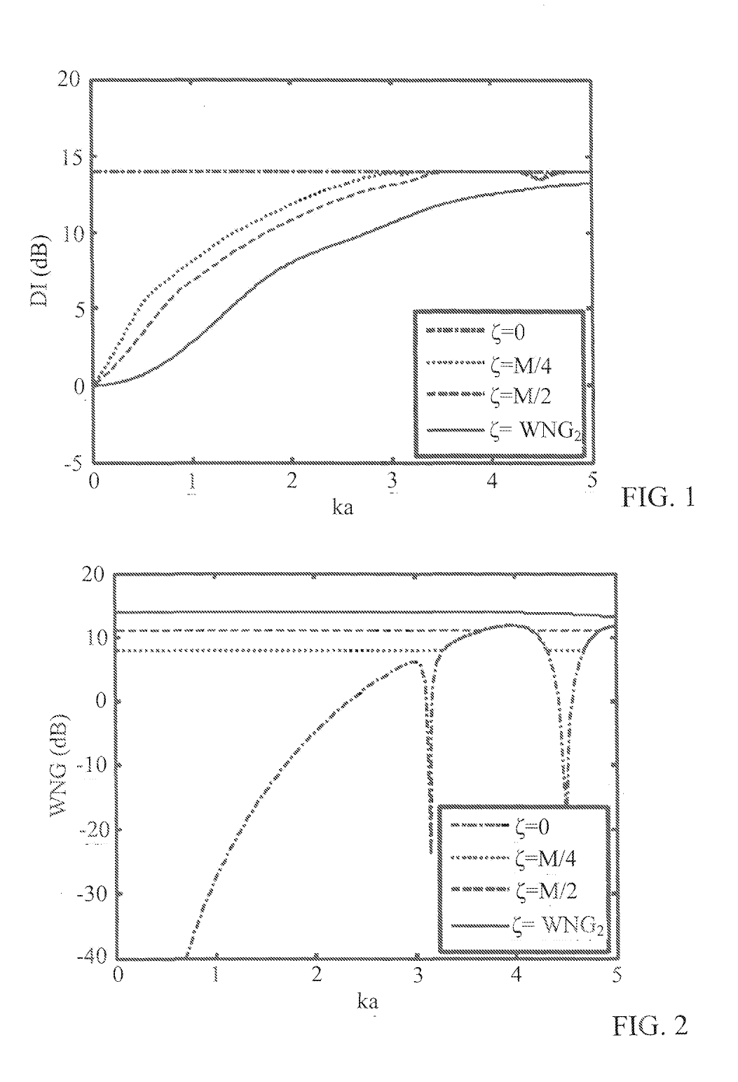

FIG. 1 is a graph of Directivity Index as a function of ka for the norm-constrained, spherical array beamformer of the first embodiment, of order N=4, for selected values of ζ;

FIG. 2 is a graph of White Noise Gain as a function of ka for the norm-constrained, spherical array beamformer of the first embodiment, of order N=4, for selected values of ζ;

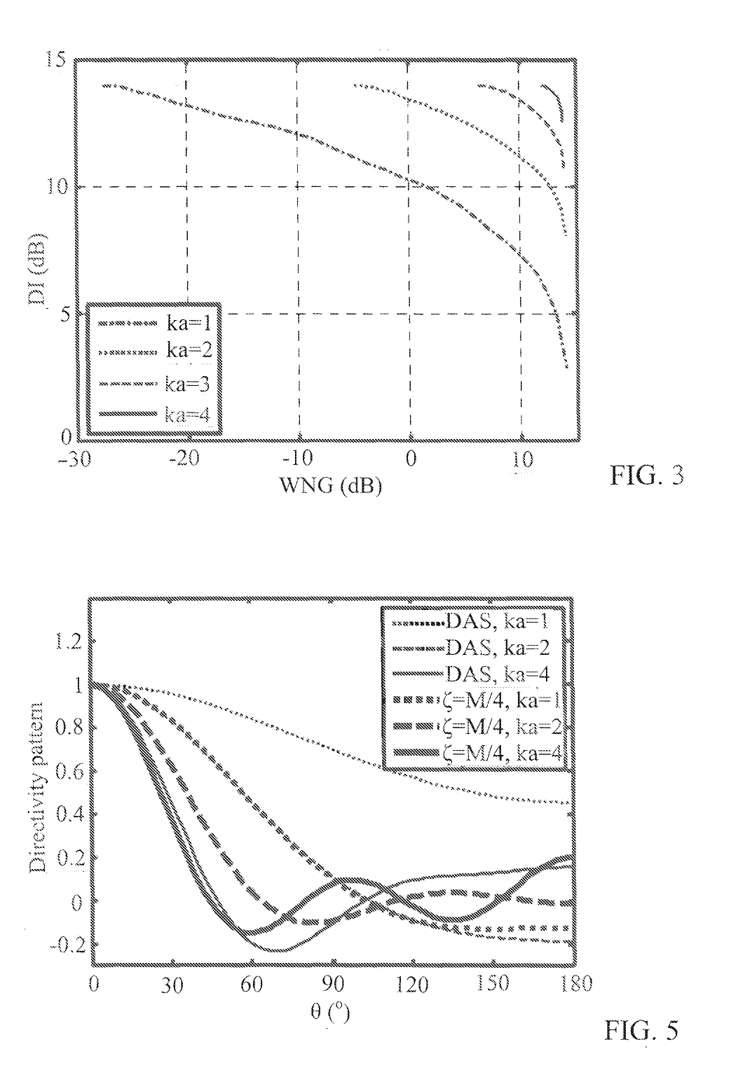

FIG. 3 is a graph of Directivity Index as a function of White Noise Gain for the norm-constrained, spherical array beamformer of the first embodiment, of order N=4, for selected values of ka;

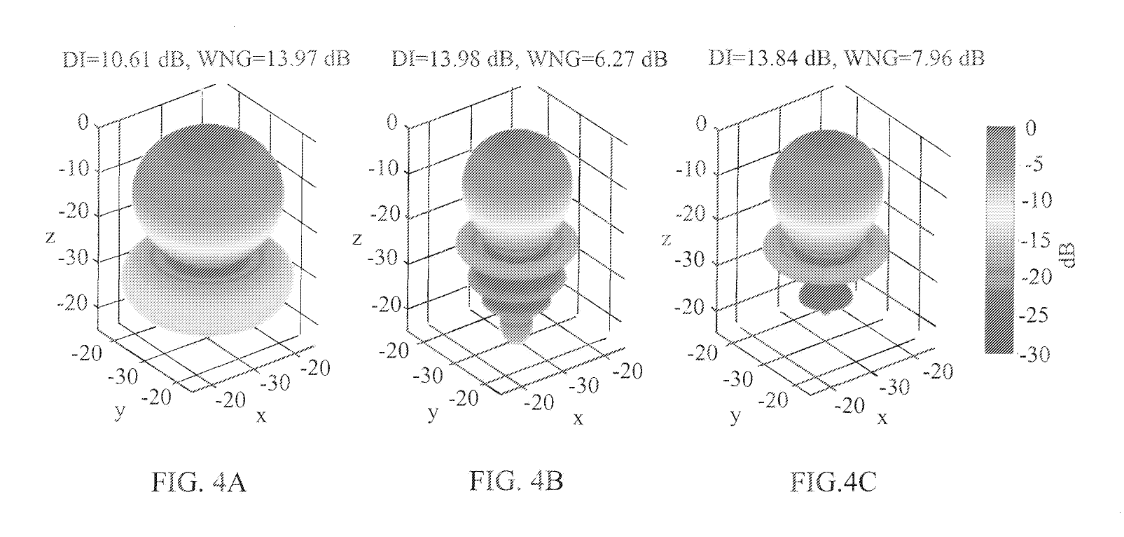

FIG. 4 shows the Directivity patterns of (a) a delay-and-sum beamformer, (b) a pure phase-mode beamformer, and (c) a norm-constrained robust maximum-DI beamformer when ka=3, all arrays being of order N=4 and using 25 microphones;

FIG. 5 shows the Directivity pattern as a function of elevation 0 for the delay-and-sum beamformer and the norm-constrained beamformer of the first embodiment with ζ=M/4, at frequencies corresponding to ka=1, 2 and 4;

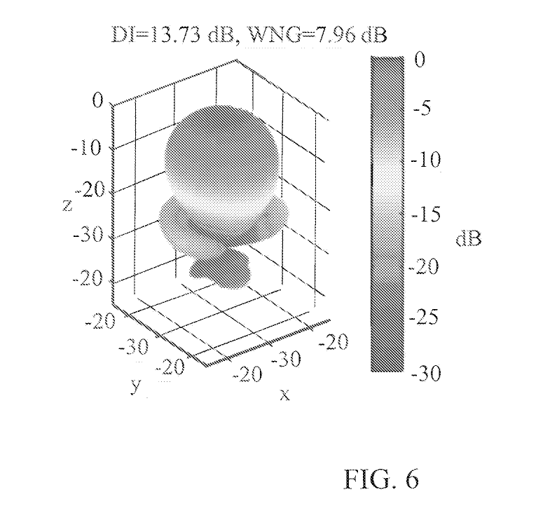

FIG. 6 shows the Directivity pattern of the norm-constrained beamformer of the second embodiment for the values of ζ=M/4 and ka=3;

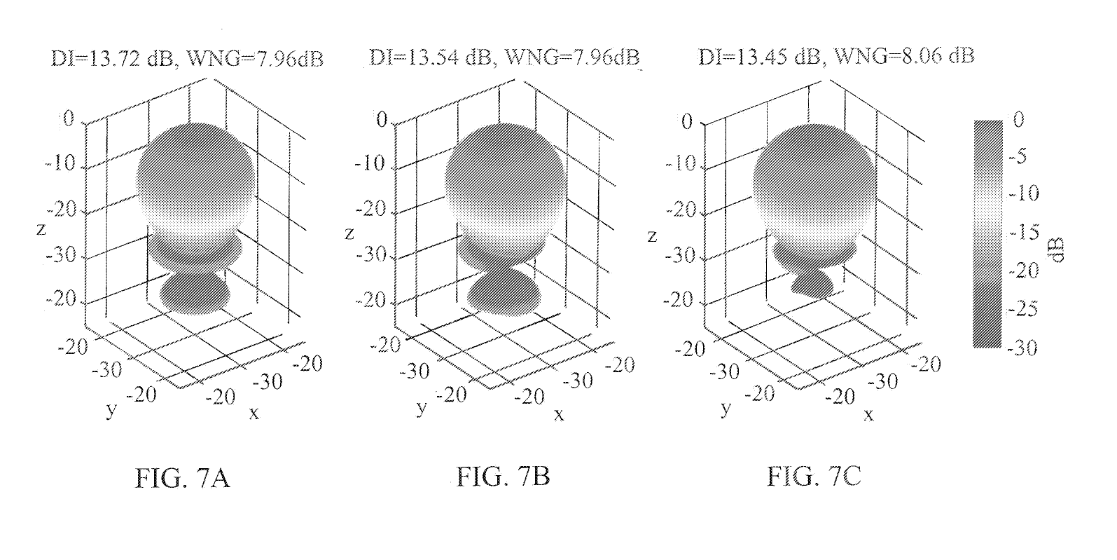

FIG. 7 shows the Directivity pattern of the robust beamformer with sidelobe control of the third embodiment when ka=3. In (a) the DI is maximized, in (b) a notch is formed around the (60°, 270°) direction with a depth of −40 dB and a width of 30°, and in (c) the output SNR is maximized, which forms a null in the direction of arrival of the interferer at (60°, 270°);

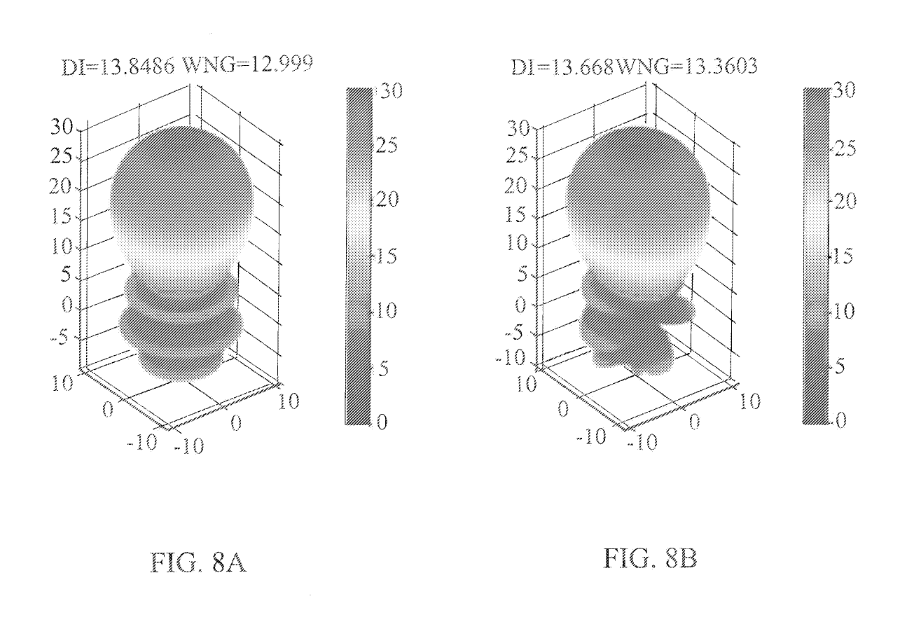

FIG. 8 shows beampatterns for (a) robust beamforming with uniform sidelobe control, and (b) robust beamforming with non-uniform sidelobe control and notch forming;

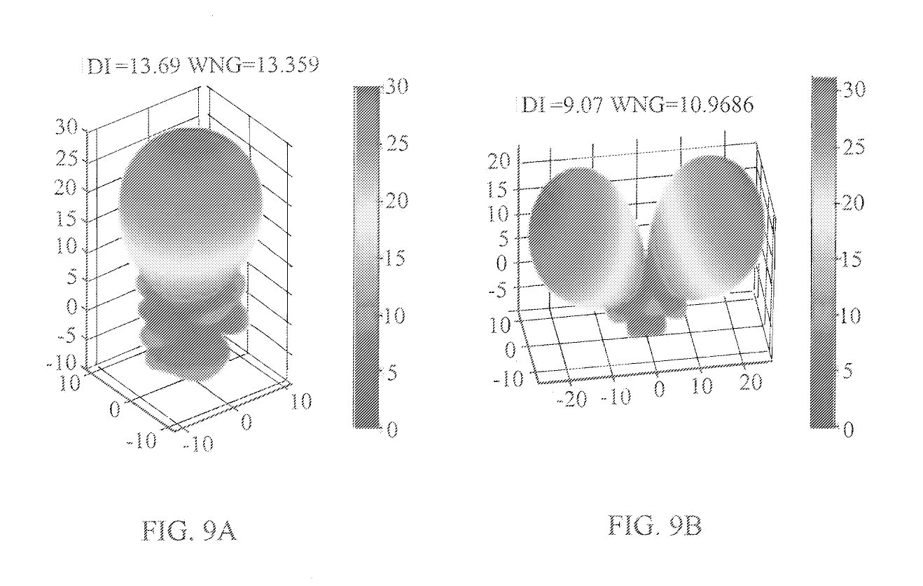

FIG. 9 shows beam patterns for (a) robust beamforming with sidelobe control and automatic multi-null steering, and (b) robust beamforming with sidelobe control, multi-mainlobe and automatic multi-null steering;

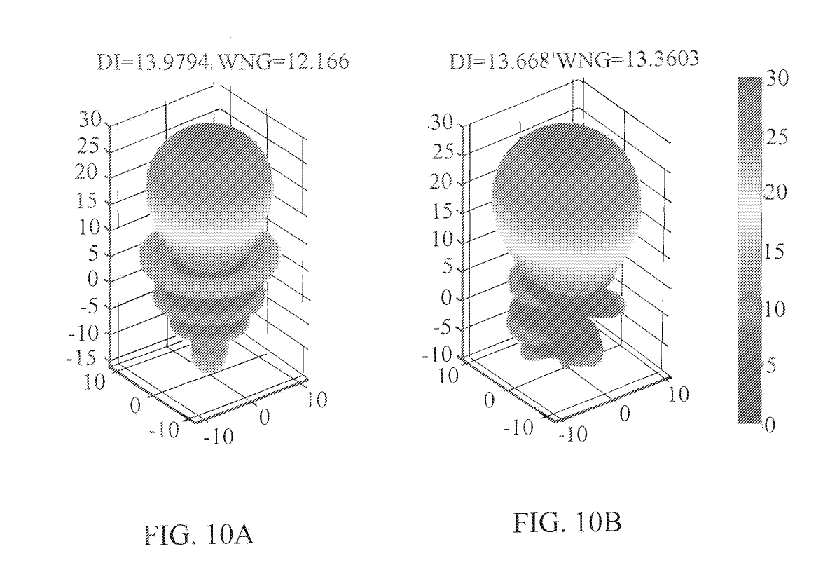

FIG. 10 shows beampatterns for (a) a single beam without sidelobe control, and (b) a single beam with non-uniform sidelobe control;

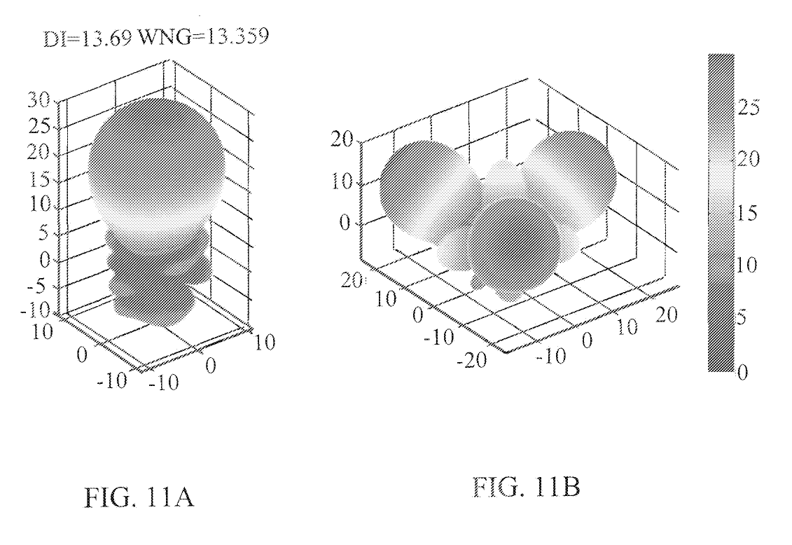

FIG. 11 shows beampatterns for (a) a single beam with uniform sidelobe control and adaptive null steering, and (b) multi-beam without sidelobe control;

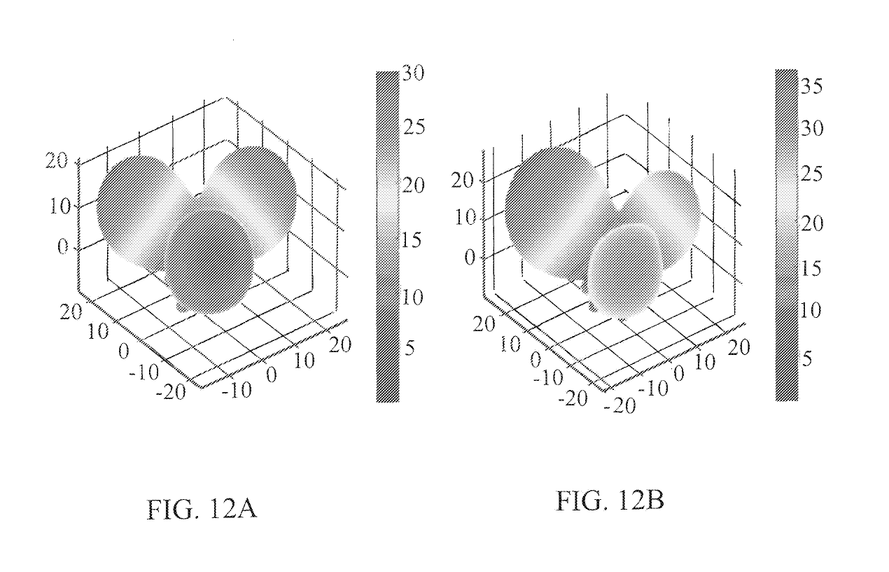

FIG. 12 shows beampatterns for (a) multi-beam beamforming with sidelobe control and adaptive null steering, and (b) multi-beam beamforming with mainlobe levels control;

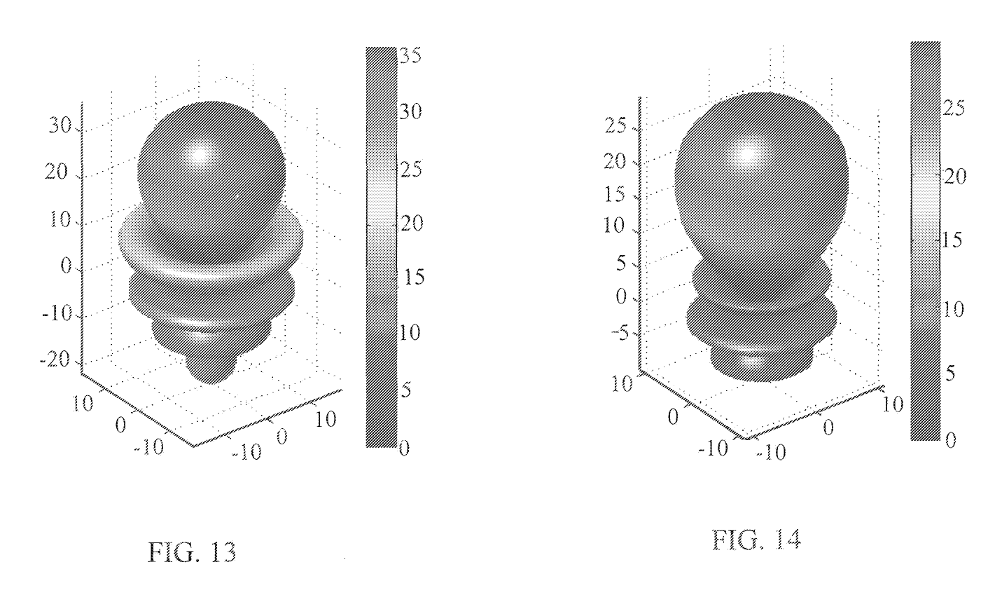

FIG. 13 shows a 4th order regular beampattern formed with a robustness constraint, but with no side lobe control;

FIG. 14 shows a 4th order optimum beampattern formed with a robustness constraint as well as side lobe control constraints;

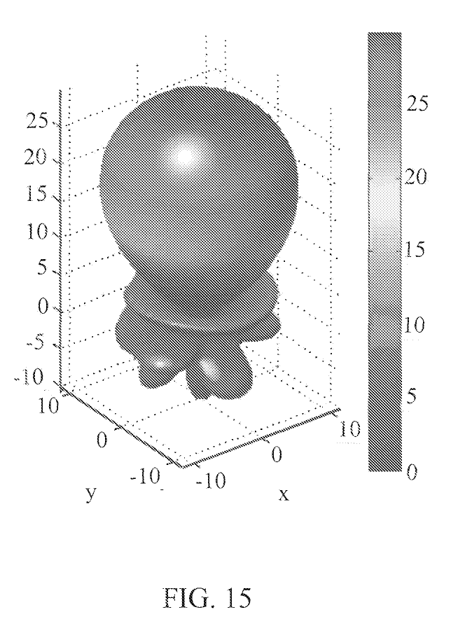

FIG. 15 shows a 4th order optimum beampattern formed with a robustness constraint and side lobe control, and with a deep null steered to the interference coming from the direction (50,90);

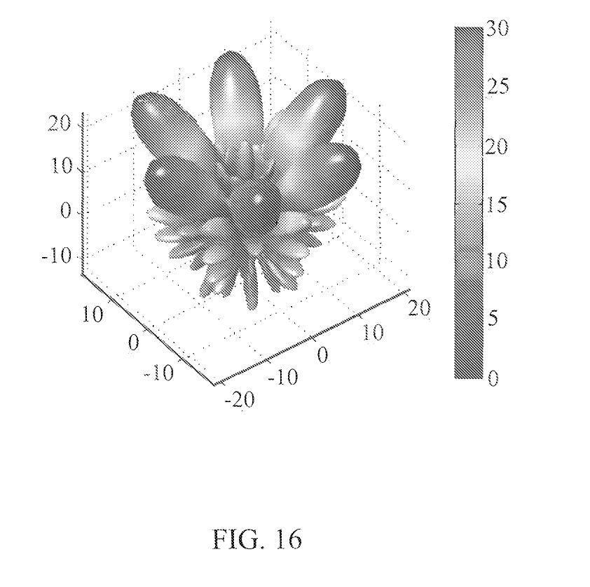

FIG. 16 shows an optimum multi-main lobe beampattern formed with six distortionless constraints in the directions of the signals of interest;

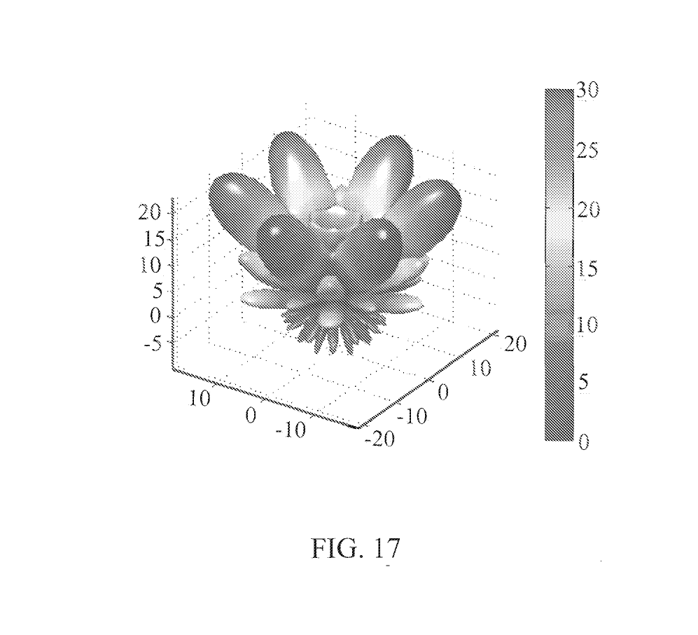

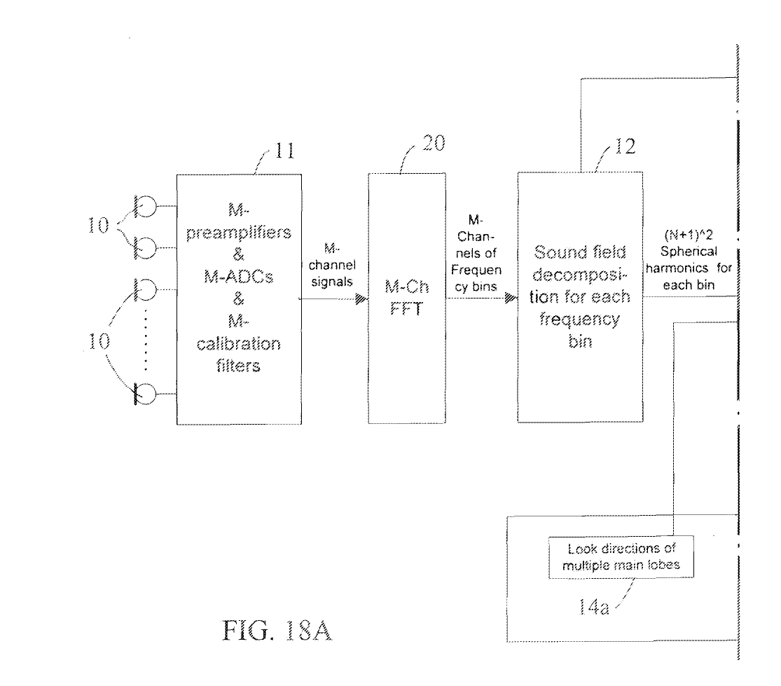

FIG. 17 shows as optimum multi-main lobe beampattern formed with six distortionless constraints in the directions of the signals of interest, a null formed at (0,0) and side lobe control for the lower hemisphere;

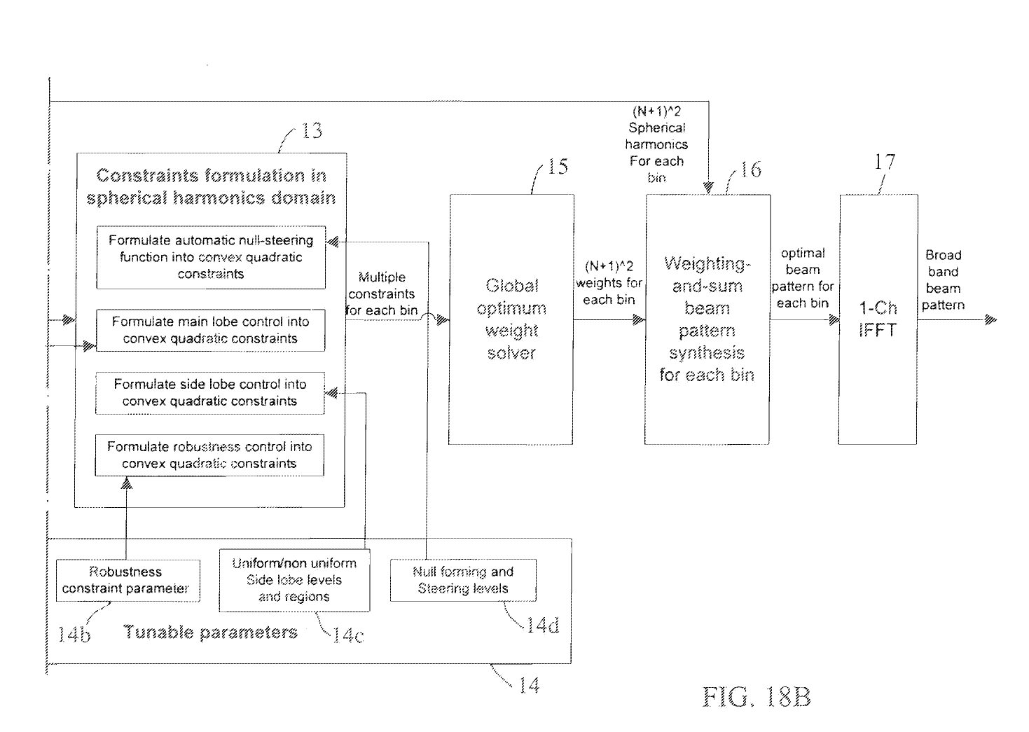

FIG. 18 is a flowchart schematically showing the method of the invention and apparatus for carrying out that method;

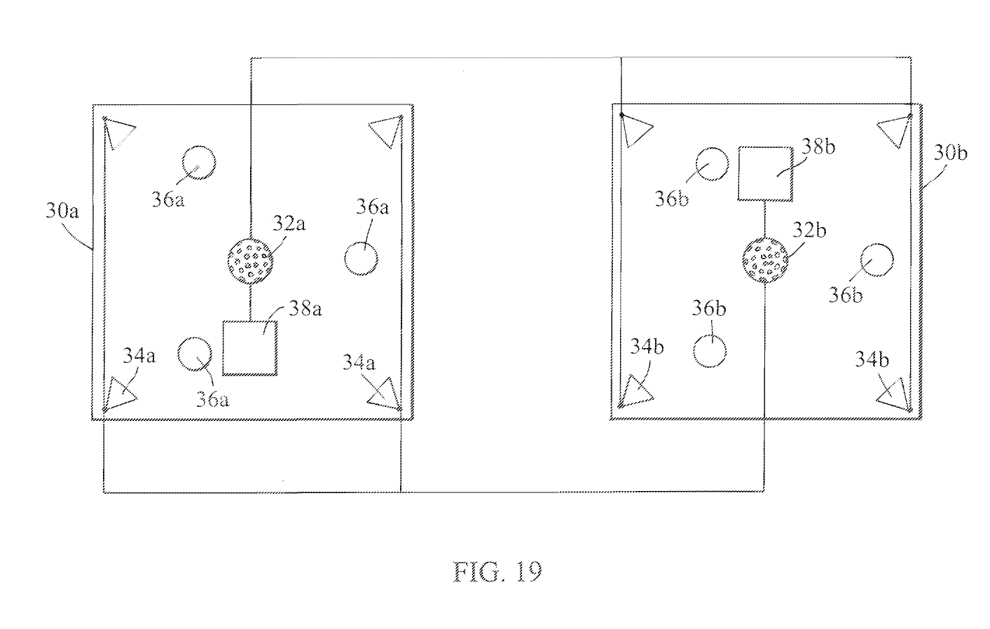

FIG. 19 shows practical implementation of the invention in a teleconferencing scenario;

FIG. 20 schematically shows a modal beamformer structure operating in the frequency domain and incorporating a steering unit;

FIG. 21 schematically shows a time-domain implementation of a broadband modal beamformer incorporating a steering unit and a number of FIR filters;

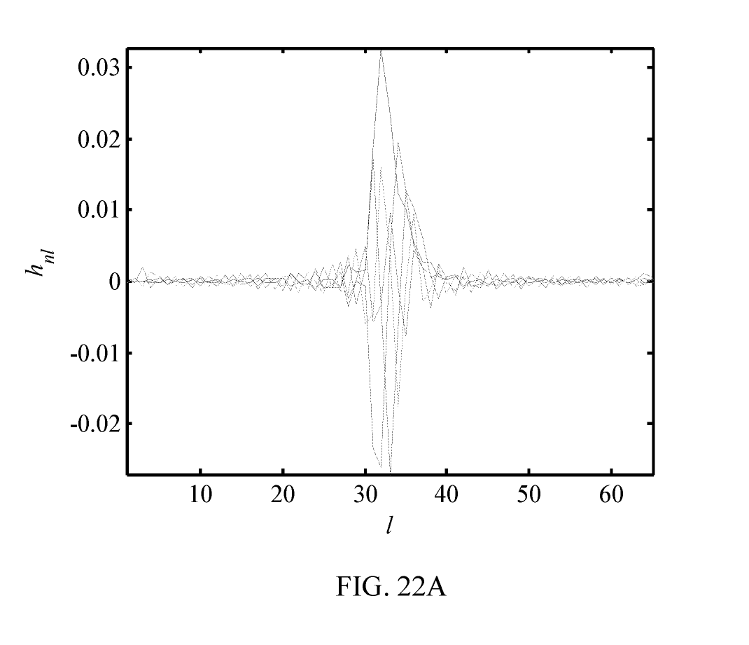

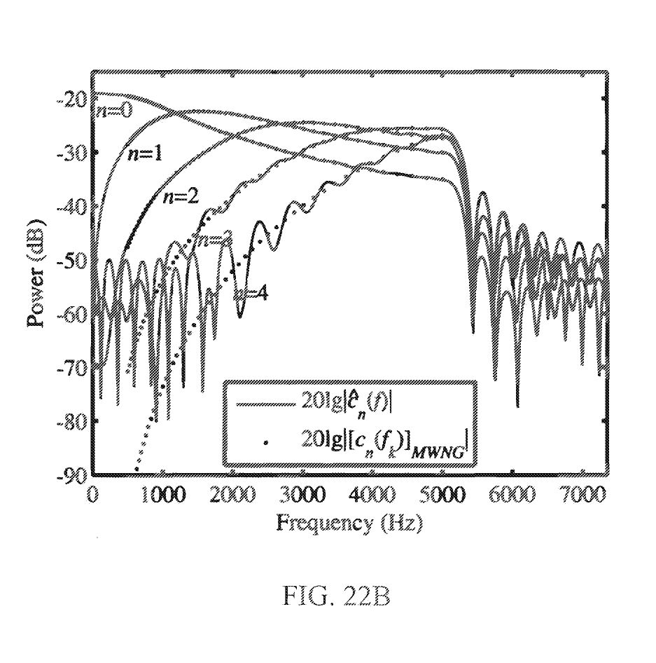

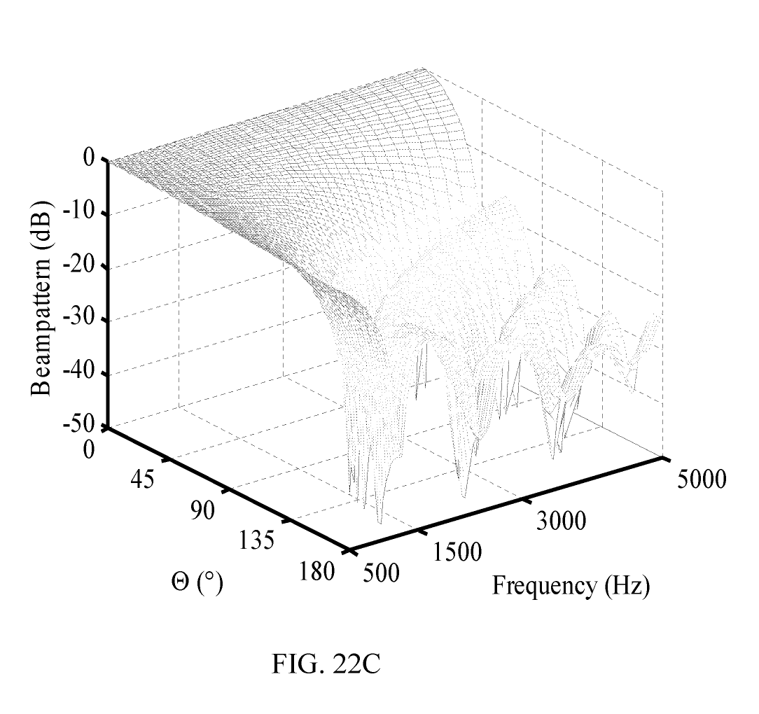

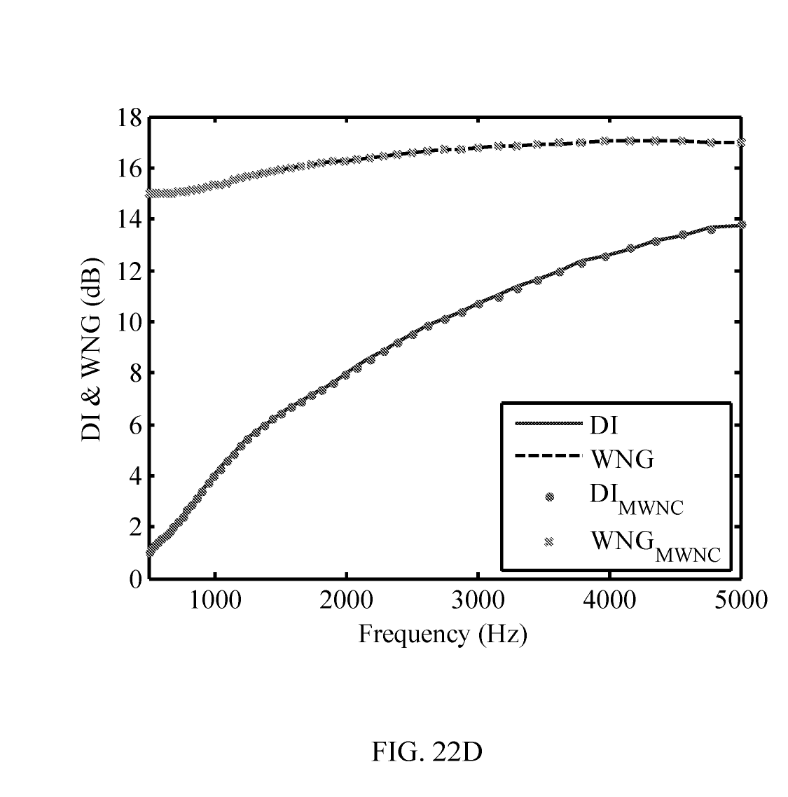

FIG. 22 shows the performance of a modal beamformer using a maximum robustness design. (a) shows the FIR filters' coefficients, (b) shows the weighting function as a function of frequency for time-domain and frequency-domain beamformers using a maximum robustness design, (c) shows the beampattern as a function of frequency and angle, and (d) shows the DI and WNG at various frequencies;

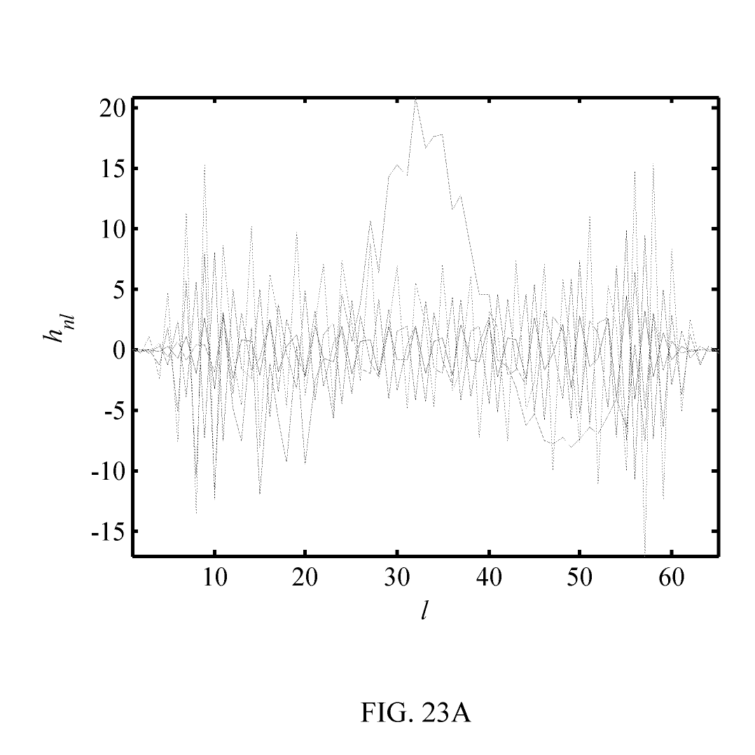

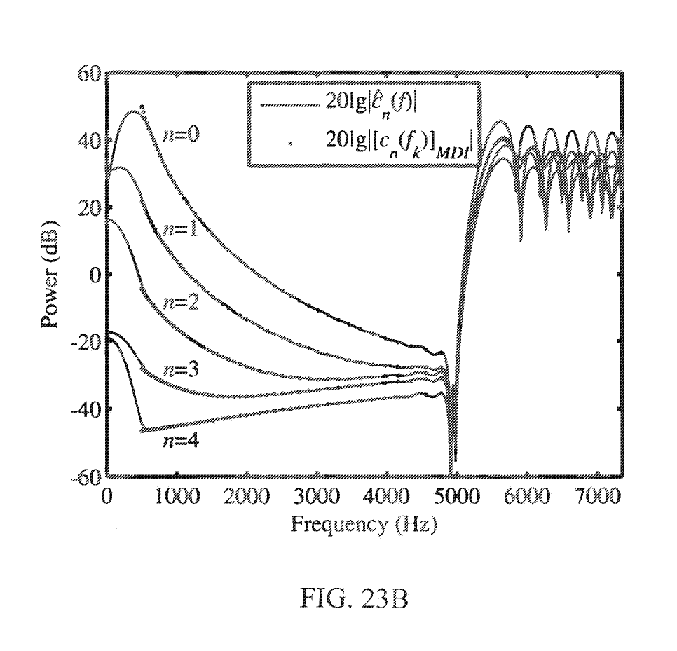

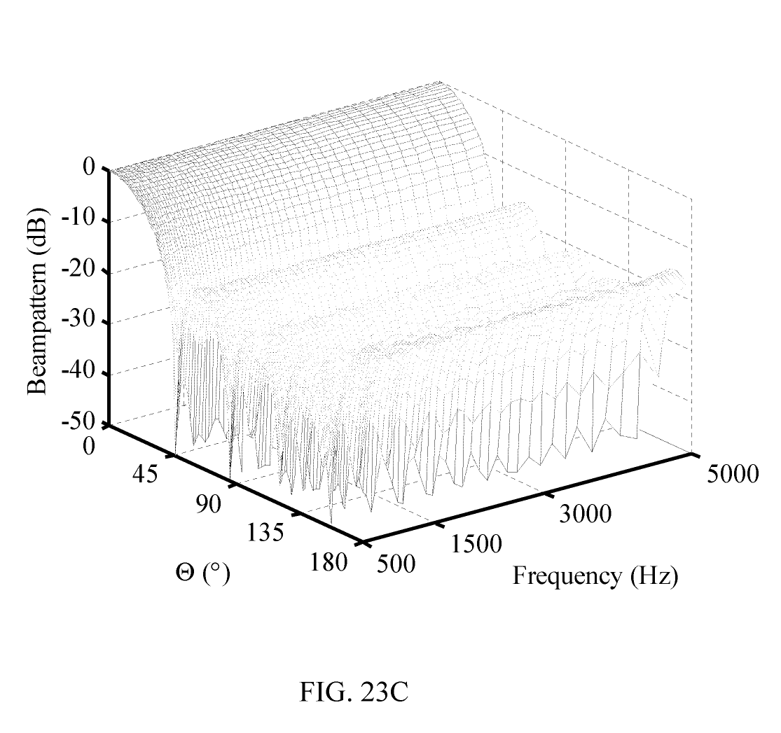

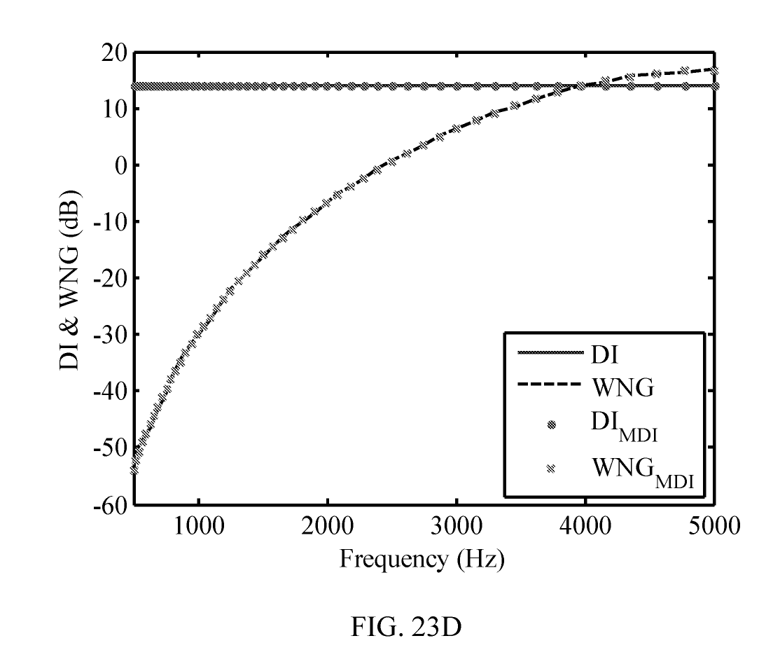

FIG. 23 shows the performance of a time-domain modal beamformer using a maximum directivity design. (a) shows the FIR filters' coefficients, (b) shows the weighting function, (c) shows the beampattern, and (d) shows the DI and WNG at various frequencies;

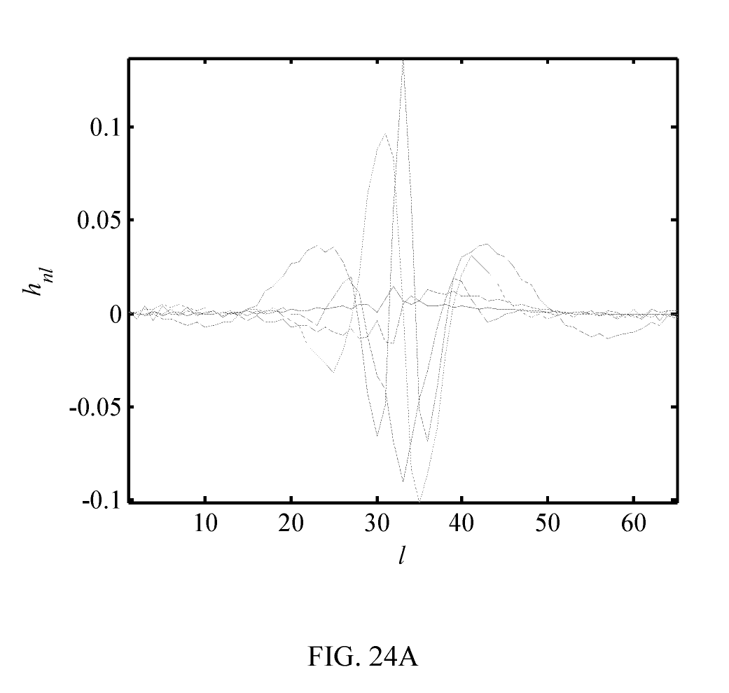

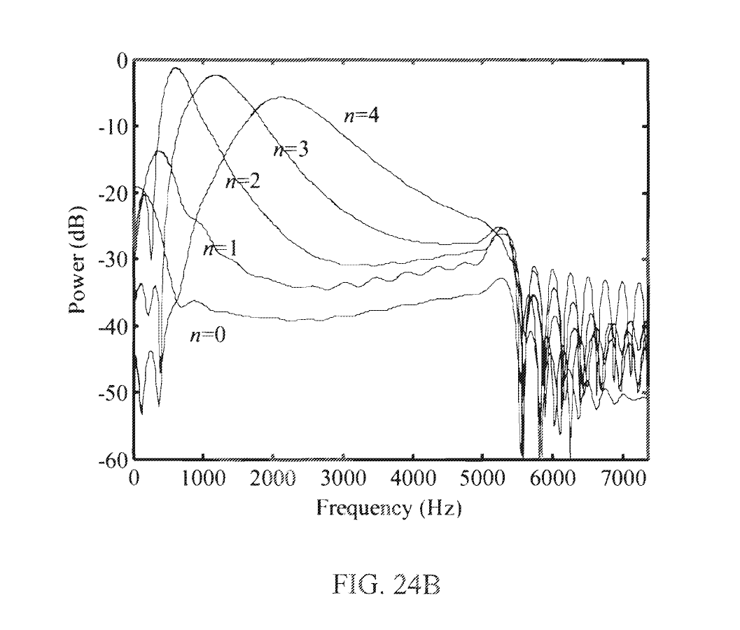

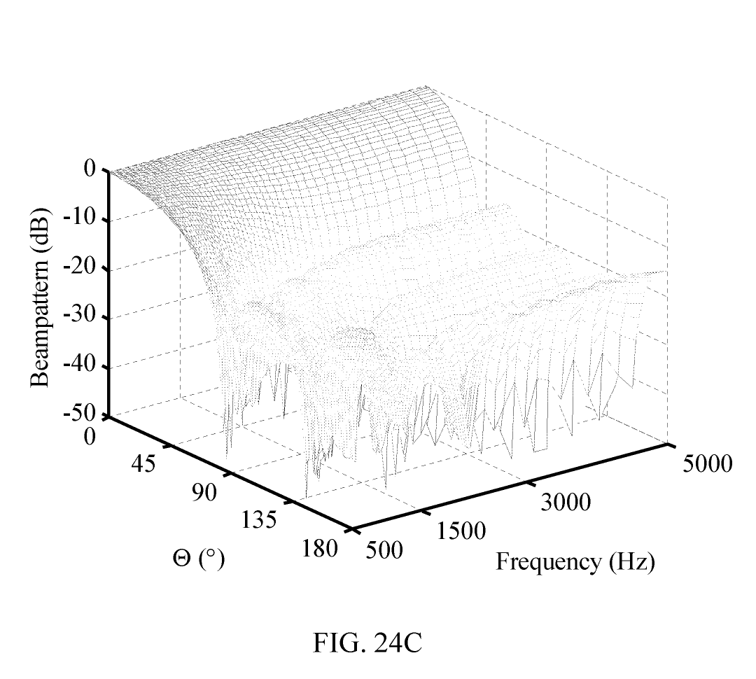

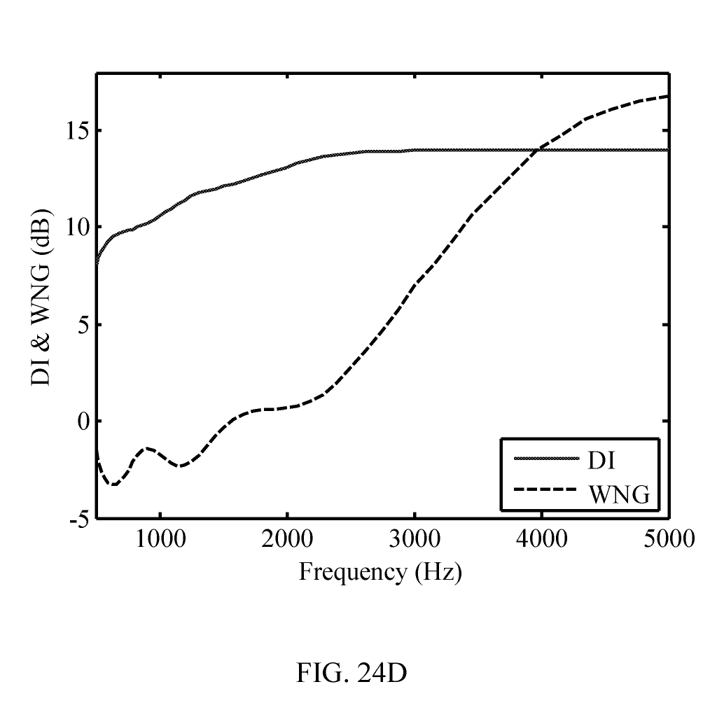

FIG. 24 shows the performance of a beamformer using a robust maximal directivity design;

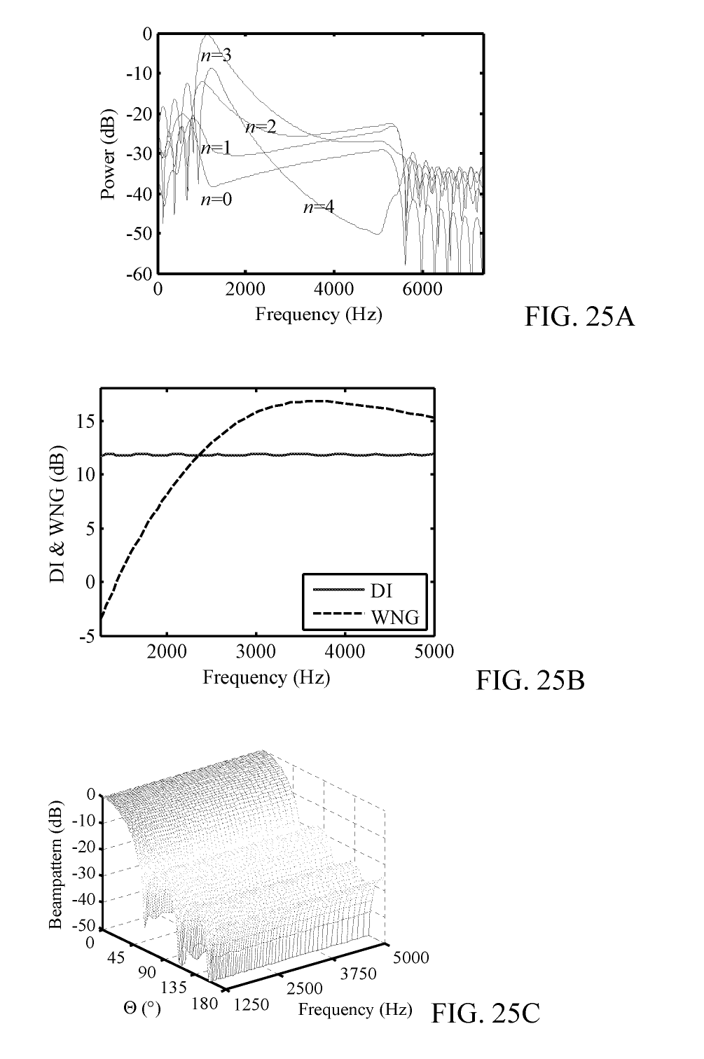

FIG. 25 shows the performance of a beamformer with frequency invariant patterns over two octaves;

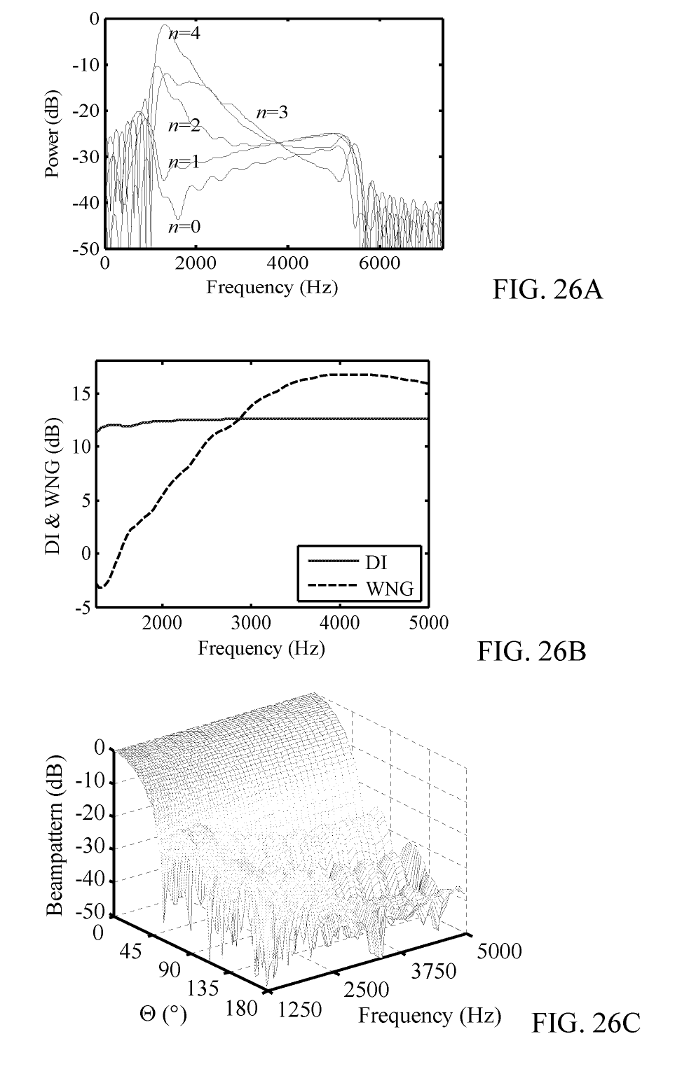

FIG. 26 shows the performance of a beamformer using multiple-constraint optimization; and

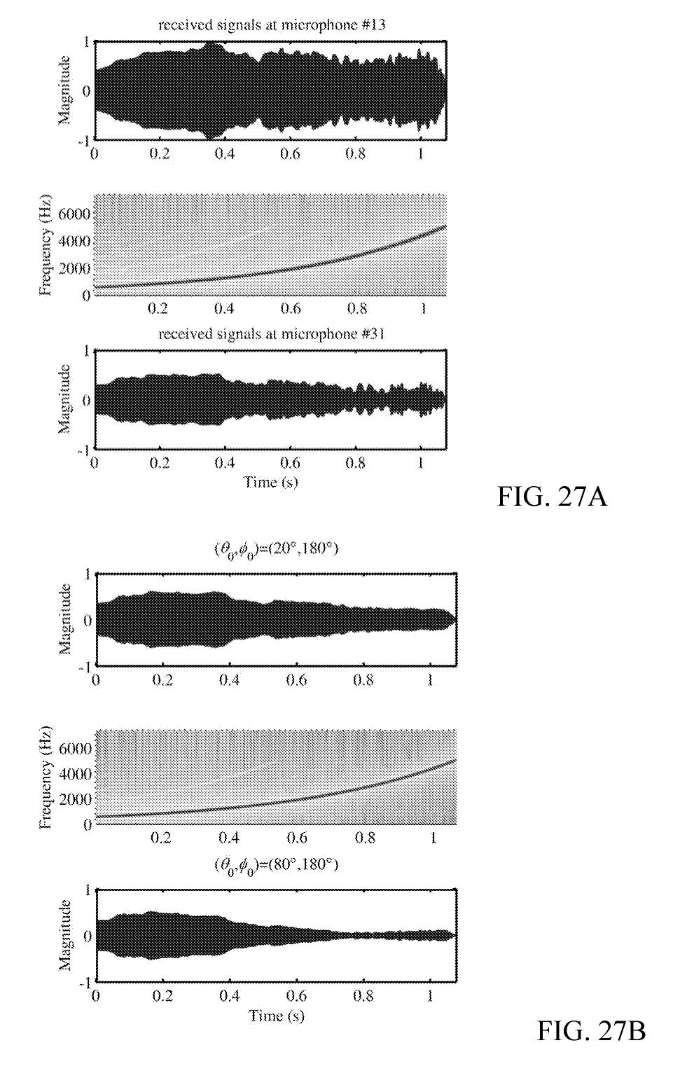

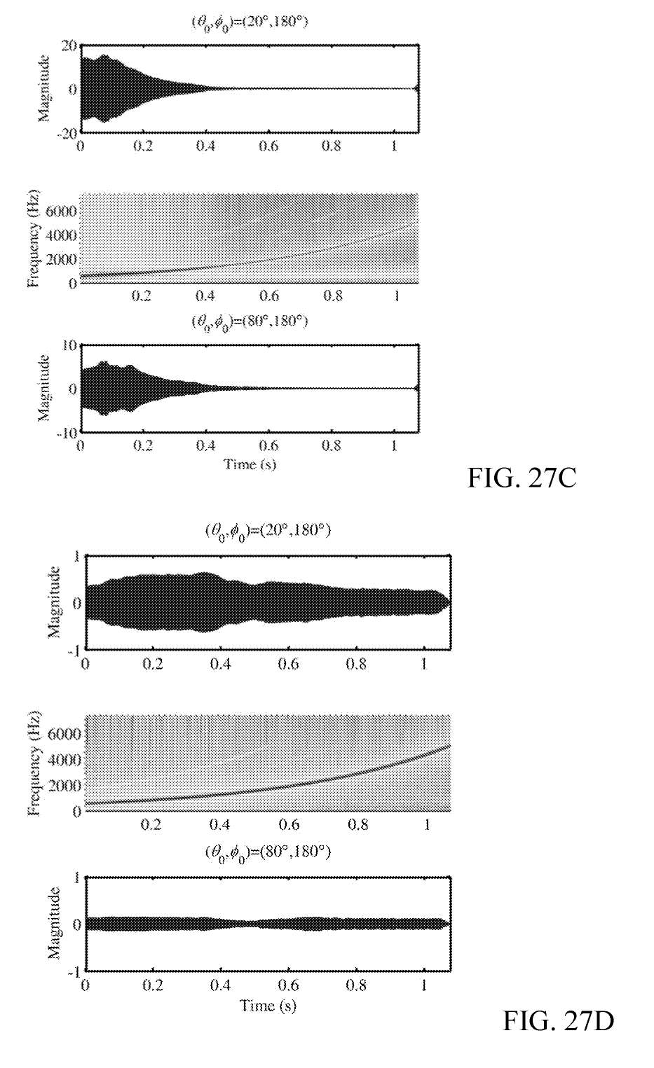

FIG. 27 shows some experimental results: (a) the received time series at two typical microphones and the spectrogram of the first one, and the output time series for two various steering directions and the spectrogram of the first one for: (b) TDMR, (c) TDMD, and (d) TDRMD modal beamformers, respectively.

Looking first at FIG. 18, a preferred embodiment of the system of the present invention is shown schematically as a beamforming system for a spherical microphone array of M microphones.

Microphones 10 (shown schematically in the figure, but in reality arranged into a spherical array, each receive sound waves from the environment around the array and convert these into electrical signals. The signals from each of the M microphones are first processed by M preamplifiers and M ADCs (Analog to Digital Convertors) and M calibration filters in stage 11. These signals are then all passed to stage 20 where a Fast Fourier Transform algorithm splits the data into M channels of frequency bins. These are then passed to stage 12 where the spherical Fourier transform is taken. Here, the signals are transformed into the spherical harmonics domain of order N, i.e. spherical harmonic coefficients are generated for each of the (N+1)² spherical harmonics of order n=0, . . . , N and of degree m=−n, . . . , n.

The spherical harmonics domain information is passed on to stage 13 for constraint formulation and also to stage 16 for post-optimization beam pattern synthesis. In stage 13, the desired parameters of the system are input from the tunable parameters stage 14. In the figure, the desired parameters which can be input include the look direction of the signal, and the main lobe width (14a), the robustness (14b), desired side lobe levels and side lobe regions (14c), and desired null locations and depths (14d).

Stage 13 takes the desired input parameters for the beampattern, combined with the spherical harmonics domain signal information from stage 12 and formulates these into convex quadratic optimization constraints which are suitable for a convex optimization technique. Constraints are formulated for automatic null-steering, main lobe control, side lobe control and robustness. These constraints are then fed into stage 15 which is the convex optimization solver for performing a numerical optimization algorithm such as an interior point method or second order cone programming and determines the optimum weighting coefficients to be applied to the spherical harmonics coefficients in order to provide the optimum beampattern under the input constraints. Note that in the space domain, the transformation to the spherical harmonics domain is not performed and the optimized weighting coefficients are applied directly to the input signals.

These determined weighting coefficients are then passed to stage 16 which combines the coefficients with the data from stage 12 as a weighted sum and finally a single channel Inverse Fast Fourier Transform is performed in stage 17 to form the array output signal.

Turning now to a practical implementation of the invention. FIG. 19 shows the invention being put into effect in a teleconferencing scenario. Two conference rooms 30a and 30b are shown. Each room is equipped with a teleconferencing system which comprises a spherical microphone array 32a and 32b for voice pick up in three dimensions, and a set of loudspeakers 34a and 34b. Each room is shown with four speakers located in the corners of the room, but it will be appreciated that other configurations are equally valid. Each room is also shown with three speaking persons 36a and 36b situated at various positions around the microphone array. The microphone arrays are connected to a beamformer and an associated controller 38a and 38b which carry out the optimization algorithm in order to generate the optimal beampatterns for the microphone arrays 32a,b.

In operation, consider that one of the speaking persons 34a is talking and everybody else is silent. The controller 38a detects the source signal and controls the beamformer to generate a beamforming pattern for the microphone array 32a in room 30a to form a mainlobe (i.e. an area of high gain) in the direction of the speaking person 36a and to minimise the array gain in all other directions.

In room 30b, the beamformer 38b detects sound sources from each of the loudspeakers 34b as interference sources. It is desirable to minimise sound from these directions in order to avoid a feedback loop between the two rooms.

Now if one of the speaking persons 36b in room 30b starts to talk over the person in room 30a, the beamformer in room 30b must immediately form a mainlobe in that speaking person's direction to ensure that his or her voice is safely transmitted to room 30a. Similarly, the beamformer 38a in room 30a must immediately form deep nulls in the beampattern in the direction of the loudspeakers 34a in order to avoid feedback with room 30b.

As the beamformers 38a and 38b are able to create multiple main lobes and multiple deep nulls and can control the directionality of these in real time, the system does not fail even if one of the speaking persons starts to walk around the room while talking. Unexpected interference, such as a police siren passing by the office can also be taken into account by controlling the directionality of the deep nulls in real time. At the same time, the beamformers 38a and 38b aim to minimise the array output power within the bounds of the applied constraints in order to minimise the influence of general background noise such as the building's air conditioning fans.

This system provides high quality spatial 3D audio with full duplex transmission, noise reduction, dereverberation and acoustic echo cancellation

A. Special Cases

We next consider several special cases of the above optimization problem (32) and compare these with the results of previous studies.

Special case 1: Maximum directivity, no WNG or sidelobe control. This is formulated as ε=0, ζ=0, {σ_{d}²}_{d=0}^{D}=0, and Q(ω)=Qᵢₛₒ(ω) in (24). This gives that R(ω)=Qᵢₛₒ(ω) and the two inequality constraints in (32) are always inactive and can be ignored.

Since the directivity factor can be interpreted as the array gain against isotropic noise, the optimization problem in this case will result in a maximum directivity factor.

The optimization problem in this case resembles a Capon beamformer in classical array processing, and the solution to (32) is easily derived as:

$$w ( k ) = \frac{( 4 π / M ) {Q}_{iso}^{- 1} ( ω ) p ( ka , {Ω}_{0} )}{{p}^{H} ( ka , {Ω}_{0} ) {Q}_{iso}^{- 1} ( ω ) p ( ka , {Ω}_{0} )} . \qquad ( 33 )$$

Using (7) and (26), and using the fact that

$${\sum }_{n = 1}^{N} {\sum }_{m = - n}^{n} {Y}_{n}^{m} ( Ω ) {Y}_{n}^{{m}^{*}} ( Ω ) = {\sum }_{n = 1}^{N} \frac{2 n + 1}{4 π} = \frac{{( N + 1 )}^{2}}{4 π} , \qquad ( 34 )$$

equation (33) can be further transformed to the following form

$$w ( k ) = \frac{{( 4 π )}^{2}}{{M ( N + 1 )}^{2}} {Y}^{*} ( {Ω}_{0} ) \cdot / {b}^{*} ( ka ) , \qquad ( 35 )$$

where ∘/ denotes element-by-element division, i.e.,

$${w}_{nm} ( k ) = \frac{{( 4 π )}^{2}}{{M ( N + 1 )}^{2}} \frac{{Y}_{n}^{{m}^{*}} ( {Ω}_{0} )}{{b}_{n}^{*} ( ka )} .$$

It can be seen that the weights in (35) are identical to the weights of a pure phase-mode spherical microphone array (See, for example, B. Rafaely, “Phase-mode versus delay-and-sum spherical microphone array processing”, IEEE Signal Process. Lett., vol. 12, no. 10, pp. 713-716, October 2005 (also cited in the introduction)) except for a scalar multiplier, which does not affect the array gain.

Using (35) in (31) and (28), gives

$$\begin{matrix}{WNG}_{1} ( k ) = \frac{M}{{( 4 π )}^{2}} \frac{{( N + 1 )}^{4}}{{\sum }_{n = 0}^{N} {\vert {b}_{n} ( ka ) \vert}^{2} ( 2 n + 1 )} , \\ and & ( 36 ) \\ {D}_{1} ( k ) = {( N + 1 )}^{2} , & ( 37 )\end{matrix}$$

(Note that these are identical to (11) and (12), respectively in the Rafaely reference cited above, with dₙ≡1 there). This result confirms that a pure phase-mode spherical microphone array of order N will have a frequency-independent maximum DI of 20 log₁₀(N+1) dB.

Special case 2: Maximum WNG, no directivity or sidelobe control. This is formulated as R(ω)=I, where I is the identity matrix, ε=∞, and ζ=0.

Clearly, the optimization problem in this case results in a minimum norm of the weight vector, or maximum white noise gain.

With Qᵢₛₒ in (33) replaced by I, the solution in this case is found to be:

$$\begin{matrix}w ( k ) = \frac{( 4 π / M ) p ( ka , {Ω}_{0} )}{{p}^{H} ( ka , {Ω}_{0} ) p ( ka , {Ω}_{0} )} = \frac{{( 4 π )}^{2} b ( ka ) \cdot {Y}^{*} ( {Ω}_{0} )}{M {\sum }_{n = 0}^{N} {\vert {b}_{n} ( ka ) \vert}^{2} ( 2 n + 1 )} , \\ and & ( 38 ) \\ {w}_{nm} ( k ) = \frac{{( 4 π )}^{2} {b}_{n} ( ka ) {Y}_{n}^{m} ( {Ω}_{0} )}{M {\sum }_{n = 0}^{N} {\vert {b}_{n} ( ka ) \vert}^{2} ( 2 n + 1 )} , & ( 39 )\end{matrix}$$

which in the case of an open sphere configuration is identical to the weights of a delay-and-sum spherical microphone array except for the scalar multiplier.

Moreover, using (38) in (31) and (28), gives

$$\begin{matrix}W N {G}_{2} ( k ) = \frac{M}{{( 4 π )}^{2}} {\sum }_{n = 0}^{N} {\vert {b}_{n} ( ka ) \vert}^{2} ( 2 n + 1 ) , \\ and & ( 40 ) \\ {D}_{2} ( k ) = \frac{{\vert {\sum }_{n = 0}^{N} {\vert {b}_{n} ( ka ) \vert}^{2} ( 2 n + 1 ) \vert}^{2}}{{\sum }_{n = 0}^{N} {\vert {b}_{n} ( ka ) \vert}^{4} ( 2 n + 1 )} . & ( 41 )\end{matrix}$$

(Note that this is the same result as in (17) and (18) of the above Rafaely reference).

Since the summation in (40) approaches (4π)² with N→∞, the delay-and-sum array achieves a frequency-independent constant WNG equal to M, which is a well-known result in classical array processing.

Special case 3: Control of directivity and WNG, no side lobe control. This case is formulated by the criterion ε=∞.

The optimization problem in this case has a form resembling a white noise gain constrained (or norm-constrained) robust Capon beamforming problem.

It is straightforward to verify that, in the case when ζ=WNG₂, the corresponding solution is a delay-and-sum array as described in Special Case 2. Furthermore, we find that with R(ω)=Qᵢₛₒ(ω) and adjusting the value of ζ in the range (0,WNG₂], we can obtain a trade-off between the pure phase-mode and delay-and-sum spherical array processing.

The following preferred embodiments of the invention are simulations of the beamformer described above, and are used to illustrate and evaluate its performance. In the simulations of FIGS. 1 to 7 below, we consider an open sphere array of order N=4, and assume that the number of microphones, M=(N+1)².

The simulations described herein have all been conducted on consumer-grade computer equipment, e.g. a notebook PC with a CPU speed of 2.4 GHz and with 2 GB of RAM. The simulations were conducted in MATLAB and took around 2 to 5 seconds for each narrowband simulation. It will be appreciated that MATLAB code is a high level programming language designed for mathematical analysis and simulation, and that when the optimization algorithms are implemented in a lower level programming language such as C or an assembly language, or if they are implemented in Field Programmable Gate Arrays, significant increases in speed can be expected.

B. Trade-Off Between Pure Phase-Mode and Delay-and-Sum Array

Let R(ω)=Qᵢₛₒ(ω) and ε=∞. The optimization problem (32) becomes a norm-constrained maximum-DI beamforming problem. The spherical array configuration provides three-dimensional symmetry. Without loss of generality, we assume that the look direction is Ω₀=[0°,0°]. For given values of ζ, we solve this optimization problem as a function of ka to get the weight vectors w(k), and insert them into (28) and (31) to get the DI and WNG, respectively. FIG. 1 and FIG. 2 show the DI and WNG, respectively, as a functions of ka for the case where ζ=0,M/2,M/4 and WNG₂. The cases with ζ=0 and ζ=WNG₂ correspond to the pure phase-mode array and delay-and-sum array, respectively. The cases ζ=M/2 and ζ=M/4 correspond, respectively, to robust beamformers with 3 dB and 6 dB degradation in WNG compared to an ideal maximum WNG of M.

FIG. 2 shows that the norm-constrained beamformer yields a WNG to be above the given threshold values, and thus can provide a good robustness. The DI of two normconstrained beamformers, ζ=M/2 and M/4, is much higher than the delay-and-sum beamformer.

Although these DI are smaller than that of a pure phase-mode beamformer, they are obtainable. That of the latter, however, is usually not obtainable due to its extreme sensitivity to even small random array errors encountered in real world applications. In addition, the very low WNG observed for two values at about ka=3.14 and 4.50 in FIG. 2 for the pure phase-mode beamformer is a well-known problem for an open-sphere array, which is avoided by using a rigid-sphere array. In summary, this example demonstrates that the norm-constrained beamforming may provide a useful trade-off between the pure phasemode and delay-and-sum array.

It is also seen that, for the case of ζ=M/2 and M/4, the weight vector norm constraint is inactive around ka =4 and 5. This is due to the fact that around these regions, the pure phase-mode beamformer has already provided a considerable WNG. Therefore, these two beamformers are identical to the pure phase-mode beamformer around these regions.

FIG. 3 shows the DI of the norm-constrained beamformer as a function of WNG at frequencies corresponding to ka=1, 2, 3 and 4. It is seen that, at higher frequency, the array has a good WNG-DI performance. At the lower frequency, its WNG-DI performance reduces significantly.

The three-dimensional array pattern of three beamformers, i.e., the delay-and-sum beamformer, the pure phase-mode beamformer, and a norm-constrained beamformer with ζ=M/4, have been calculated by (23) for the frequency corresponding to ka=3. These results are displayed in FIG. 4, where we have included a normalization factor M/4π so the amplitudes of the patterns at the look direction are equal to unity (or to 0 dB). It is seen that the array patterns in this case are symmetric around the look direction. It's also seen that the norm-constrained beamformer yields a narrower mainlobe than the delay-and-sum beamformer. The values of the DI and WNG of these beamformers are also displayed in the figures. The WNG in FIG. 4(c) is exactly 10 log₁₀(M/4)=7.96 dB.

FIG. 5 compares the directivity pattern as a function of elevation θ for the delay-and-sum (DAS) beamformer and norm-constrained beamformer with ζ=M/4, at frequencies corresponding to ka=1, 2, and 4. It is worth noting that the directivity pattern of the pure phase-mode beamformer is frequency independent and, as suggested by FIG. 2, is identical to that of the norm-constrained beamformer with ζ=M/4 at ka=4.

C. Robust Beamforming with Interference Rejection

Consider the special case 3 described above. The noise is assumed to be isotropic noise. A signal and an interferer are assumed to impinge on the array from (0°,0°) and (−90°,60°) with the signal(interferer)-to-noise ratio at each sensor of 0 dB and 30 dB, respectively. We assume that exact covariance is known, and expressed by the theoretical array covariance matrix of R(ω) (24).

In this case, the optimization problem becomes a norm-constrained robust Capon beamforming problem and results in a beamformer with high array gain at the expense of some degradation in directivity.

FIG. 6 shows the resulting array patterns for the values of ζ=M/4 and ka=3. As expected, the array patterns have deep null in the direction of arrival of the interferer. The array pattern in this case, unlike those by pure phase-mode beamformer and delay-and-sum beamformer shown in FIG. 4, is no longer symmetric around the look direction.

D. Robust Beamforming with Sidelobe Control and Interference Rejection

FIG. 4 and FIG. 6 show that the sidelobe levels of these array patterns at ka=3 are about from −13.2 dB to −16.3 dB. Such values may be too high for many applications, leading to severe performance degradation in the case of unexpected or suddenly appearing interferers. For applications in such situations we now consider examples of beamformers with sidelobe control.

We first assume isotropic noise with R(ω)=Qᵢₛₒ(ω) and take a case where ka=3, ζ=M/4 and ε=0.1, i.e., the desired sidelobe level is −20 dB. The sidelobe region is defined as Ω_{SL}={(θ,φ)|θ≧45°}. The solution of the optimization problem of (32) is the norm-constrained maximum DI beamformer with sidelobe control. The resulting array pattern is shown in FIG. 7(a). The sidelobe level is below −20 dB as specified.

Consider now that in addition to sidelobe control, we want to design a notch around the direction (60°,270°) with depth of −40 dB and the width of 30°. In this case, the desired sidelobe structure is direction-dependent. By setting ε=0.01 in the desired notch region while maintaining ε=0.1 in the other sidelobe region, and solving the optimization problem, the resulting array pattern is shown in FIG. 7(b). It is seen that the prescribed notch is formed and that the low sidelobe level of −20 dB is maintained.

Consider the scenario described in section C above. Assume that we want to control the sidelobes to be below −20 dB, i.e., ε=0.1. Keep the other parameters the same as those used in section C. The beamformer weight vector is determined by solving the optimization problem (32). The resulting array pattern is shown in FIG. 7(c). Compared to FIG. 4(a), it is seen that the sidelobes by this method are strictly below −20 dB besides the null in the direction of arrival of the interference.

In the following simulations of a rigid sphere array, with order N=4, multiple mainlobe constraints are applied and non-uniform sidelobe constraints are applied. To form multiple mainlobes in the beampattern, each direction of interest must be made subject to a non-distortion constraint. For non-uniform sidelobe control, instead of requiring all sample points in the sidelobe region to be below a given threshold, sidelobe directions can each be subjected to different thresholds. For example, an interference direction can be subjected to a stronger constraint while the remaining directions can be subjected to a less strong threshold. With these extra constraints (for K mainlobe constraints and L sidelobe constraints), the optimization problem (32) can be restated as:

$${min}_{w} {w}^{H} ( k ) R ( ω ) w ( k ) , \\ subject to {w}^{H} ( k ) p ( ka , {Ω}_{k} ) = 4 π / M , k = 1 , … , K , \\ \vert {w}^{H} ( k ) p ( ka , {Ω}_{SL , l} ) \vert \leq {ɛ}_{l} \cdot 4 π / M , l = 1 , … , L , \\ ‖ w ( k ) ‖ < \sqrt{\frac{4 π}{M ζ ( k )}} . \qquad ( 42 )$$

Again, due to the nature of this optimization formulation, convex optimization techniques can be applied, in particular as it is a convex second order cone problem, SOCP techniques can be used to solve it. With these techniques, even with the large number of constraints involved, the problem can still be optimized efficiently and in real time.

Further simulations are used to evaluate the performance of this beamformer. We consider a rigid sphere array of order N=4, and M=(N+1)². We assume that the look direction is [0°,0°] for a single mainlobe case, ka=3, signal and interferer to noise ratios at each sensor are 0 dB and 30 dB, and a WNG constraint is set to 8 dB. FIG. 8(a) shows the array pattern with sidelobe region defined as Ω_{SL}={(θ,φ)|θ≧45°} and sidelobe level below −20 dB. FIG. 8(b) shows the performance of non-uniform sidelobe control; a notch around the direction (60°,270°) with a depth of −40 dB and a width of 30° is formed, and the remaining sidelobe level is still maintained at −20 dB.

In FIG. 9(a), we assume two interferences impinge on array from (60°,190°) and (90°,260°), then it is seen that the nulls are automatically formed and steered to the direction of arrival of the interferences with sidelobes strictly below −20 dB. FIG. 9(b) shows the performance of multi-mainlobe formation and automatic multi-null steering with −20 dB sidelobe control, here we assume two desired signals incident on array from (40°,0°) and (40°,180°), with three interferences impinging from (0°,0°), (45°,90°), and (50°,270°). Actual directivity index (DI) and WNG values are also calculated for FIGS. 8 and 9.

In the following analysis, we consider a compact spherical microphone array placed in a room. All signal sources are assumed to be located in the far field of the aperture (so that they may be approximated by plane waves incident on the array), and the early reflections in the room are modelled as point sources while the late reverberation is modelled as isotropic noise. Now we assume that L+D source signals impinge on the sphere from directions Ω₁,Ω₂, . . . , Ω_{L},Ω_{L+1}, . . . , Ω_{L-D}, and in addition noise is present. Then the space domain sound pressure for each microphone position can be written as:

$$x ( ka , {Ω}_{s} ) = {\sum }_{l = 1}^{L} [ p ( ka , {Ω}_{l} , {Ω}_{s} ) {S}_{l} ( ω ) + {\sum }_{lr = 1}^{R} p ( ka , {Ω}_{lr} , {Ω}_{s} ) {α}_{lr} {S}_{lr} ( ω ) exp ( {iωτ}_{lr} ) ] + {\sum }_{d = 1}^{D} [ p ( ka , {Ω}_{d} , {Ω}_{s} ) {S}_{d} ( ω ) + {\sum }_{dr = 1}^{R} p ( ka , {Ω}_{dr} , {Ω}_{s} ) {α}_{dr} {S}_{dr} ( ω ) exp ( {iωτ}_{dr} ) ] + N ( ω , {Ω}_{s} ) , s = 1 , 2 , … , M , \qquad ( 43 )$$

where {Sₐ(ω)}ₐ₌₁^{L+D} are the L+D source signal spectrums, {Sₗᵣ(ω)}ₗᵣ₌₁^{R} and {S_{dr}(ω)}_{dr=1}^{R} are their R early reflections, α and τ denote the attenuation and propagation time of early reflections, and N(ω,Ωₛ) is the additive noise spectrum. The first term in (43) corresponds to the L desired signals that it is desired to capture, and the second term in (43) corresponds to D interferences.

The spherical Fourier transform of x(ka,Ωₛ) is given by

$${x}_{nm} ( ka ) = {\sum }_{l = 1}^{L} [ {p}_{nm} ( ka , {Ω}_{l} ) {S}_{l} ( ω ) + {\sum }_{lr = 1}^{R} {p}_{nm} ( ka , {Ω}_{lr} ) {α}_{lr} {S}_{lr} ( ω ) exp ( {iωτ}_{lr} ) ] + {\sum }_{d = 1}^{D} [ {p}_{nm} ( ka , {Ω}_{d} ) {S}_{d} ( ω ) + {\sum }_{dr = 1}^{R} {p}_{nm} ( ka , {Ω}_{dr} ) {α}_{dr} {S}_{dr} ( ω ) exp ( {iωτ}_{dr} ) ] + {N}_{nm} ( ω ) , n = 0 , 1 , … , N , m = [ - n , n ] , \qquad ( 44 )$$

where Nₙₘ(ω) is the spherical Fourier transform of noise, a N is the spherical harmonics order which satisfies M≧(N+1)² as before.

Array processing can then be performed in either the space domain or the spherical harmonics domain, and the array output y(ka) is calculated as

$$y ( ka ) = {\sum }_{s = 1}^{M} {α}_{s} x ( ka , {Ω}_{s} ) {w}^{*} ( k , {Ω}_{s} ) = {\sum }_{n = 0}^{N} {\sum }_{m = - n}^{n} {x}_{nm} ( ka ) {w}_{nm}^{*} ( k ) , \qquad ( 45 )$$

As before, αₛ depends on the sampling scheme. For uniform sampling, αₛ=4π/M.

As with embodiments, in the beamformer of the following embodiments, multiple mainlobe directions are maintained and the sidelobe levels are controlled, while the array output power is minimized in order to adaptively suppress the interferences coming from outside beam directions. Furthermore, for the purpose of improving system robustness, a weight norm constraint (i.e. white noise gain control) is also applied to limit the norm of array weights to a chosen threshold.

To ensure that the L desired signals coming from directions Ω₁=Ω₁,Ω₂, . . . , Ω_{L}, will be well captured and equalized, we define a L×(N+1)² manifold matrix

\tilde{P}ₙₘ=[p(ka,Ω₁),p(ka,Ω₂), . . . , p(ka,Ω_{L})]^{T}

and a L×1 vector column containing L desired mainlobe levels

A=[A₁·4π/M,A₂·4π/M, . . . , A_{L}·4π/M]^{T}

where 4π/M is the normalization factor. Then the problem of multi-beam forming with tractable mainlobe levels can be formulated as a single linear equality constraint:

\tilde{P}ₙₘw(k)=A, (46)

and the levels for L mainlobe responses can be controlled by setting different A values. This becomes particularly useful in the simple application of equalization of the voice amplitudes of L desired speakers, who have different speech levels. This occurs mainly due to the fact that they sit at different positions in the room.

Similarly to the above description of the embodiments, in order to guarantee all sidelobes strictly below given threshold values εⱼ, we can formulate a set of quadratic inequality constraints

|p^{H}(ka,Ω_{SL,j})w(k)|²≦εⱼ·(4π/H)², j=1,2, . . . , J, (47)

where Ω_{SL,j} denote the sidelobe regions, and they are also utilized to control the beam widths of the multiple mainlobes.

As in the above embodiments, adaptive mainlobe formation and multi-null steering is achieved by minimizing the array output power in run time while applying various constraints. As stated before in (22), the array output power is given by

P₀(ω)=E[∥y(ka)∥²]=w^{H}(k)R(ω)w(k)=∥R(ω)^{1/2}w(k)∥², (48)

where E[·] denotes the statistical expectation, and R(ω) denotes the covariance matrix of x. For simplification, we assume that the early reflections in the room are much lower than direct sound, so that R(ω) has the form

$$R ( ω ) = {\sum }_{a = 1}^{L + D} {R}_{a} ( ω ) + {R}_{n} ( ω ) , \qquad ( 49 )$$

where Rₐ(ω) is the signal covariance matrix corresponding to the ath signal, and Rₙ(ω) is the noise covariance matrix.

Now, by introducing a variable ξ, the optimization problem can be reformulated as

$${min}_{w} ξ , subject to ‖ {R ( ω )}^{1 / 2} w ( k ) ‖ \leq ξ . \qquad ( 50 )$$

The weight vector norm constraint derived previously in (31) for a single mainlobe also applies to the multi-mainlobe case since it controls the dynamic range of array weights to avoid large noise amplification at the array output.

Combining this with (46), (47) and (50), the optimization problem of (32) can be expressed as

$${min}_{w} ξ \\ subject to ‖ {R ( ω )}^{1 / 2} w ( k ) ‖ \leq ξ \\ {P}_{nm} w ( k ) = A \\ ‖ w ( k ) ‖ < \sqrt{δ \frac{4 π}{M}} \\ {\vert {p}^{H} ( ka , {Ω}_{SL , j} ) w ( k ) \vert}^{2} \leq {ɛ}_{j} \cdot {( 4 π / M )}^{2} , j = 1 , 2 , … , J . \qquad ( 51 )$$

Thus a single optimization problem has been formulated which accomplishes multiple mainlobe formation with different mainlobe levels, sidelobe control with multiple null formation and steering and a robustness constraint. Further, this optimization problem is a convex second order cone optimization problem and can therefore be solved efficiently using, second order cone programming, in real time.

It will be noted in the above that the weight vector norm constraint has been expressed with the threshold constant δ in the numerator rather than ζ in the denominator. The following simulations indicate values of δ which have been used.

In the following simulations, consider a rigid sphere with r=5 cm is sampled by M=(N+1)² microphones, and ka=3. Signal and interferer to noise ratios at each microphone are 0 dB and 30 dB. A uniform grid of 5° is used to discretize the sidelobe region. Unless otherwise stated, the theoretical data covariance matrix R(ω) is used in adaptive beamforming examples for convenience.

For single beam cases (L=1), assume order N=4, A₁=1, the look direction is [0°,0°], and the WNG constraint is set to 8 dB (δ=0.159). FIG. 10(a) shows the regular single beam pattern synthesis using (51) without sidelobe control and adaptive null steering constraints. FIG. 10(b) shows the performance of nonuniform sidelobe control. The main sidelobe region is defined as Ω_{SL}={(θ,φ)|θ≧45°} with sidelobe level uniformly below −20 dB (εⱼ=0.01), while defining a notch around the direction (60°,270°) with depth of −40 dB (εⱼ=0.0001) and the width of 30°. In FIG. 11(a), remove the notch, and assume two interferences impinge on array from [60°,190°] and [90°,260°], then it is seen that the nulls are automatically formed and steered to the direction of arrival of the interferences with sidelobes still strictly below −20 dB. Note that actual WNG and directivity index (DI) values are calculated for all the single beam cases.

It is seen that in FIG. 10(b), the mainlobe becomes a little wider, and DI is also 0.3 dB lower than that without sidelobe control. However these costs are acceptable in practical applications. The reason for degradation is that the beamforming performance parameters, i.e., the beamwidth, sidelobe level, DI, and robustness are all mutually correlated. The algorithm illustrated herein provides a suitable compromise among these conflicting objectives.

For multi-beam examples (L=3), we use an array order of N=5 to obtain more degrees of freedom. Assume three desired signals incident on array from [60°,0°], [60°,120°] and [60°,240°]. FIG. 11(b) shows the multi-beam forming performance with A_{1,2,3}=1 and δ=0.4. FIG. 12(a) shows the acceptable performance of multi-beam with adaptive null steering and −20 dB sidelobe control, assuming that interferences come from [0°,0°],[65°,60°],[65°,180°], and [65°,300°]. Next, suppose that the amplitude of the second desired signal is 6 dB lower than the other two signals, and we can just set A₂=2 and δ=1, to simply equalize the sound levels. The beam pattern is shown in FIG. 12(b), and shows that we obtain around 6 dB amplitude enhancement for signals coming from the second mainlobe direction.

FIGS. 13 to 17 show further simulations which illustrate the benefits of the optimal beamformer of the present invention. FIG. 13 shows a 4th order regular beampattern formed with a robustness constraint, but with no side lobe control. By contrast, FIG. 14 shows a 4th order optimum beampattern obtained according to the invention, formed with a robustness constraint as well as side lobe control constraints. The main lobe is in the region of 45 degrees from the positive z-axis. FIG. 15 shows a 4th order optimum beampattern formed in accordance with the invention, with a robustness constraint and side lobe control, and with a deep null steered to the interference coming from the direction (50,90).

FIG. 16 shows an optimum multi-main lobe beampattern formed in accordance with the invention with six distortionless constraints in the directions of the signals of interest, thus forming six main lobes in the beampattern. FIG. 17 shows an optimum multi-main lobe beampattern formed in accordance with the invention, with six distortionless constraints in the directions of the signals of interest, with a null formed at (0,0) and side lobe control for the lower hemisphere.

### TIME DOMAIN EXAMPLES

The following provides several numerical examples to illustrate the performances of the time domain approach to array pattern synthesis for a broadband modal beamformer.

In the examples considered below, we consider a rigid spherical array of radius 4.2 cm with M=32 microphones located at the center of the faces of a truncated icosahedron. An order of N=4 is used for sound field decomposition and αₛ≡4π/M. The sampling frequency is ƒₛ=14700 Hz. The frequency band [ƒ_{L},ƒ_{U}] is discretized using K=51 frequency grids ƒₖ=ƒ_{L}·10^{lg(ƒ}^{_{U}}^{/ƒ}^{_{L}}^{)*(k-1)/(K-1)}, k=1,2, . . . , K. The length of the FIR filters is L=65. Unless otherwise stated, we assume Θ_{ML}=[0°:2°:40°] and Θ_{SL}=[48°:2°:180°], which means a uniform grid of 2° is used to discretize the directions.

T.A. Maximum Robustness Design

Referring to equation (T42), assume that ƒ_{L}=500 Hz, ƒ_{U}=5000 Hz. Let l=4 , μ₁=∞, μ₂=∞, μ₃=∞. The optimization problem becomes

$${min}_{h} {h}^{T} h , subject to {h}^{T} u ( {f}_{k} , 0 ) = 4 π / M , k = 1 , 2 , … , K . \qquad ( T43 )$$

A solution of this problem is called a time-domain Maximum-Robust (TDMR) modal beamformer. The FIR filter h is determined by solving the optimization problem (T43) and its subvectors h₀,h₁, . . . , h_{N} are show in FIG. 22(a). We substitute h into (T23) to get ĉₙ(ƒ) and display them in FIG. 22(b). For comparison purposes, [cₙ(ƒₖ)]_{MWNG}, which are calculated using (T17), are also shown in this figure. It is seen that the weights of the time-domain Maximum-Robust modal beamformer, ĉₙ(ƒ), approximate that of the frequency-domain Maximum-WNG modal beamformer, [cₙ(ƒₖ)]_{MWNG}, within the frequency band [ƒ_{L},ƒ_{U}].

Using (T25), the beampattern as a function of frequency and angle are calculated on a grid of points in frequency and angle. The resulting beampatterns are shown in FIG. 22(c), where we have included a normalization factor M/4π so the amplitudes of the patterns at the look direction are equal to unity (or to 0 dB).

The DI and WNG of the are calculated by using (T38) and (T15), respectively. The DI and WNG of the frequency-domain Maximum-WNG modal beamformer are also calculated for comparison purposes. The results are shown in FIG. 22(d) for various frequencies.

T.B. Maximum Directivity Design

Let l=1, μ₂=∞, μ₃=∞, μ₄=∞. The optimization problem (T42) becomes a maximum directivity design problem. The resulting beamformer is referred to as time-domain Maximum-directivity (TDMD) modal beamformer.

Assume that ƒ_{L}=500 Hz, ƒ_{U}=5000 Hz. The resulting FIR filters h₀, h₁, . . . , h_{N}, the weighting function ĉₙ(ƒ), the beampatterns, and the DI and WNG are shown in FIGS. 23(a),(b),(c), and (d), respectively. For comparison purposes, the weights function [cₙ(ƒₖ)]_{MDI} (T16), and DI and WNG of the frequency-domain Maximum-DI modal beamformer, are also shown in the figures. It is seen that the weights of the time-domain modal beamformer using maximum directivity design approximate that of its frequency-domain counterpart within the frequency band [ƒ_{L},ƒ_{U}].

As compared to FIGS. 22(a), (b) and (d), it is seen that the coefficients of the FIR filters and thus the resulting weighting function of the TDMD beamformer are quite large and the WNG at low frequency is too small, all imply that this beamformer lacks robustness.

T.C. Maximal Directivity with Robustness Control

In order to improve the robustness of the beamformer, the broadband white noise gain constraint should be imposed. This can be formulated as l=1, μ₂=∞, μ₃=∞, and μ₄ is a user parameter. The resulting beamformer is referred to as time-domain Robust Maximal-directivity (TDRMD) modal beamformer.

Assume that ƒ_{L}=500 Hz, ƒ_{U}=5000 Hz, and μ₄=4π/M. The resulting FIR filters h₀,h₁, . . . , h_{N}, the weighting function ĉₙ(ƒ), the beampatterns, and the DI and WNG are shown in FIGS. 24(a),(b),(c), and (d), respectively.

It is seen from FIG. 24(d) that the WNG of this beamformer is higher than −3 dB, which at low frequency is much higher than that of the maximum directivity design as shown in FIG. 23. The DI of this beamformer is much higher that that of the maximum robustness design as shown in FIG. 22. Hence, the results show that this design provides a good tradeoff between the directivity and the robustness.

T.D. Frequency-Invariant Beamformer

Assume that we want to synthesize a frequency-independent broadband beampattern. We reduce the bandwidth to two octaves so that ƒ_{L}=1250 Hz, ƒ_{U}=5000 Hz. Let l=1, ∥₂=10^{-1.5}·4π/M, q₁=2, μ₃=∞, μ₄=2π/M, Θ_{ML}=[0°:2°:180°]. The results are shown in FIG. 25. It is seen that the expected frequency-independent beampatterns are obtained, and the WNG is moderate.

T.E. Optimal Beamformer with Multiple Constraints

Assume that ƒ_{L}=1250 Hz, ƒ_{U}=5000 Hz. Let l=1, μ₂=0.1·4π/M, q₁=2, μ₃=10^{-14/20}·4π/M, q₂=∞, μ₄=10^{-4/10}·4π/M, Θ_{ML}=[0°:2°:40°] and Θ_{SL}=[48°:2°:180°]. The resulting results are shown in FIG. 26. It is seen that all the constraints are guaranteed and the trade-off among multiple performance measures are obtained.

Experimental Results

The Eigenmike® microphone array from MH Acoustics was employed, which is a rigid spherical array of radius 4.2 cm with 32 microphones located at the center of the faces of a truncated icosahedron. The experiment was conducted in an anechoic room which is anechoic down to 75 Hz, and the Eigenmike® was placed in the center of the room for recording. A loudspeaker, which was located 1.5 meters away from the Eigenmike® roughly in the direction (20°,180°), was used to play a swept-frequency cosine signal (ranging from 100 Hz to 5 kHz). The sound was recorded by the Eigenmike® with the sampling frequency of 14.7 kHz and 16 bit per sample.

The signals received at two typical microphones (i.e., No. 13 microphone that on the sunny side and No. 31 microphone that on the dark side) are respectively shown in the upper and lower plot of FIG. 27(a). The spectrogram of the signal shown in the upper plot using short-time Fourier transform is shown in the middle plot.

The TDMR modal beamformer presented in subsection T.A. is used. When the beam is steered to the direction of arrival, i.e., (20°,180°), the beamformer output time series and the spectrogram are shown in the upper and middle plot of FIG. 27(b), respectively. The lower plot of FIG. 27(b) shows the output time series when the beam is steered to another direction (80°,180°), which is 60° away from the direction of arrival.

We apply the TDMD and TDRMD modal beamformer presented in subsection T.B. and T.C. to the same microphone array data, respectively. We repeat the process above, the same results as in FIG. 27(b) for the two methods are shown in FIGS. 27(c) and (d), respectively.

We look at the upper plots of FIGS. 27(b), (c) and (d). It is seen that the output of the TDMRD beamformer is similar as that of the TDMR beamformer. For the TDMD beamformer, however, its magnitude at the lower frequency is much larger. The reason is that the norm of the weights at the lower frequency is very large and leads to a quite large output even to slight mismatches between the presumed and actual array response vectors. In other words, this beamformer is quite sensitive even to slight mismatches.

Comparing the lower plot of FIG. 27(b) with that of FIG. 27(d), it is noted that the magnitude of the time series of the TDMR beamformer is much larger than that of the TDRMD beamformer, especially at the lower frequency, which means that the beamwidth of the former is wide than the latter. This can also be found from the beampatterns shown in FIG. 22 and FIG. 24. Hence, the results presented in FIG. 27 show that the TDRMD beamformer provides a good trade-off between the directivity and the robustness.

The above examples have presented the real-valued time-domain implementation of the broadband modal beamformer in the spherical harmonics domain. The broadband modal beamformer in these examples is composed of the modal transformation unit, the steering unit, and the pattern generation unit, although it will be understood that the steering unit is optional and can be omitted if it is necessary to generate a beam pattern which is not rotationally symmetric about the look direction. The pattern generation unit is independent of the steering direction and is implemented using filter-and-sum structure. The elegant spherical harmonics framework leads to a more computationally efficient optimization algorithm and implementation scheme than conventional element-space based approaches. The broadband array response, the beamformer output power against both isotropic noise and spatially white noise, and the mainlobe spatial response variation have all been expressed as functions of the FIR filters' tap weights. The FIR filters design problem has been formulated as a multiply-constrained problem, which ensures that the resulting beamformer can provide a suitable trade-off among multiple conflicting array performance measures such as directivity, mainlobe spatial response variation, sidelobe level, and robustness.

It can be seen from all of the above that the problem of optimal beamformer design for spherical microphone arrays has been addressed by formulating the optimization problem as a multiple-constrained convex optimization problem which can be solved efficiently using a Second Order Cone Programming solver. It has been demonstrated that the resulting beamformer can provide a suitable trade-off among multiple performance measures such as directivity index, robustness, array gain, sidelobe level, mainlobe width, and so on as well as providing for multiple mainlobe formation multiple adaptive null forming for interference rejection, both with varying gain constraints for different lobes/regions. It is evident that the approach provides a flexible design tool since it covers the previously studied delay-and-sum beamformer, and the pure phase-mode beamformer as special cases, while also allowing far more complex optimization problems to be solved within the allowable timeframe.

### Annex

The following section is some background description of spherical Fourier transforms and spherical-harmonics based beamforming and it derives some results which have been used in this description.

The standard Cartesian (x,y,z) and spherical (r,θ,φ) coordinate systems are used. Here, elevation θ and azimuth φ are angular displacements in radians measured from the positive z-axis and x-axis of the projection onto the plane z=0, respectively. Consider a unit magnitude plane wave impinging on a sphere of radius a from direction Ω₀=(θ₀,φ₀) and with a time factor exp(iωt) which is suppressed throughout this application. Here, i=\sqrt{−1}, and ω is the temporal radian frequency.

The total sound pressure on the sphere surface at an observation point (a,Ωₛ) for a wavenumber k can be written using spherical harmonics as

$$p ( ka , {Ω}_{0} , {Ω}_{s} ) = {\sum }_{n = 0}^{∞} {b}_{n} ( ka ) {\sum }_{m = - n}^{n} {Y}_{n}^{m *} ( {Ω}_{0} ) {Y}_{n}^{m} ( {Ω}_{s} ) , \qquad ( 1 )$$

where k=∥k∥=ω/c with c being the sound speed, Yₙ^{m} is the spherical harmonics of order n and degree m, superscript * denotes complex conjugation, and bₙ(ba) depends on the sphere configuration, e.g. rigid sphere, open sphere, etc., as given by

$${b}_{n} ( ka ) = \{ \begin{matrix}4 π {i}^{n} {j}_{n} ( ka ) & open sphere \\ 4 π {i}^{n} ( {j}_{n} ( ka ) - \frac{{j}_{n}^{′} ( ka )}{{h}_{n}^{′} ( ka )} {h}_{n} ( ka ) ) & rigid sphere ,\end{matrix} \qquad ( 2 )$$

where jₙ and hₙ are the nth order spherical Bessel and Hankel functions, and j′ₙ and h′ₙ are their derivatives with respect to their arguments, respectively.

The spherical harmonics are the solutions to the wave equation, or the Helmholtz equation in spherical coordinates. They are given by

$${Y}_{n}^{m} ( Ω ) = {Y}_{n}^{m} ( θ , φ ) = \sqrt{\frac{( 2 n + 1 )}{4 π} \frac{( n - m ) !}{( n + m ) !}} {P}_{n}^{m} ( cos θ ) {e}^{i m φ} , \qquad ( 3 )$$

where Pₙ^{m}(cos θ) denotes the associated Legendre function. The spherical harmonics functions are orthonormal and satisfy

∫_{Ω∈S}_{²}Y_{n′}^{m′}(Ω)Y*ₙ^{m}(Ω)dΩ=δ_{n-n′}δ_{m-m′}, (4)

where δ_{n-n′} and δ_{m-m′} are the Kronecker delta functions and the integral ∫_{Ω∈S}_{²}dΩ=∫₀^{2π}∫₀^{π} sin θdθdφ covers the entire surface of the unit sphere S².

The spherical harmonics decomposition, or the spherical Fourier transform of a squared integrable function p on the unit sphere, denoted by pₙₘ, and the inverse transform, are given by

$$\begin{matrix}{p}_{nm} ( ka , {Ω}_{0} ) = {\int }_{Ω ∈ {S}^{2}} p ( ka , {Ω}_{0} , Ω ) {Y}_{n}^{m *} ( Ω ) d Ω , & ( 5 ) \\ p ( ka , {Ω}_{0} , Ω ) = {\sum }_{n = 0}^{∞} {\sum }_{m = - n}^{n} {p}_{nm} ( ka , {Ω}_{0} ) {Y}_{n}^{m} ( Ω ) . & ( 6 )\end{matrix}$$

Applying the spherical Fourier transform (5) to a plane wave as expressed by (1) gives the spherical harmonics domain expression of p(ka,Ω₀,Ω):

pₙₘ(ka,Ω₀)=bₙ(ka)Y*ₙ^{m}(Ω₀). (7)

Now, to analyze the properties of a spherical array, we assume a signal-of-interest (SOI) plane wave from direction Ω₀, and D interference plane waves from directions Ω₁, . . . , Ω_{d}, . . . , Ω_{D} that impinge on the sphere. Adding uncorrelated noise, the sound pressure on the sphere surface can be written as:

$$x ( ka , {Ω}_{s} ) = β p ( ka , {Ω}_{0} , {Ω}_{s} ) {S}_{0} ( ω ) + {\sum }_{d = 1}^{D} p ( ka , {Ω}_{d} , {Ω}_{s} ) {S}_{d} ( ω ) + N ( ω ) , \qquad ( 8 )$$

where {S_{d}(ω)}_{d=0}^{D} are the D+1 source signals spectra, N(ω) is the additive noise spectrum, and β is a binary parameter that indicates whether the SOI is present or not.

The spherical Fourier transform of x(ka,Ωₛ) is given by

$$\begin{matrix}{x}_{nm} ( ka ) = {\int }_{Ω ∈ {S}^{2}} x ( ka , Ω ) {Y}_{n}^{m *} ( Ω ) d Ω \\ = {\int }_{Ω ∈ {S}^{2}} [ \begin{matrix}β p ( ka , {Ω}_{0} , {Ω}_{s} ) {S}_{0} ( ω ) + \\ {\sum }_{d = 1}^{D} p ( ka , {Ω}_{d} , {Ω}_{s} ) {S}_{d} ( ω ) + N ( ω )\end{matrix} ] {Y}_{n}^{m *} ( Ω ) d Ω \\ = β {p}_{nm} ( ka , {Ω}_{0} ) {S}_{0} ( ω ) + \\ {\sum }_{d = 1}^{D} {p}_{nm} ( ka , {Ω}_{d} ) {S}_{d} ( ω ) + {N}_{nm} ( ω ) ,\end{matrix} \qquad ( 9 )$$

where Nₙₘ(ω)=∫_{Ω∈S}_{²}N(ω)Yₙ^{m}*(ω)dω denotes the spherical Fourier transform of noise.

Array processing can be carried out in either the space domain or the spherical harmonics domain, respectively by calculating the integral of the product of the array input signal and the array weight function over the entire sphere, or by a similar weighting and summation in the spherical harmonics domain. Denoting the aperture weighting function by w, the array output is given as the integral of the product between array input signal and the complex conjugated weighting function w* over the entire sphere,

$$y ( ka ) = {\int }_{Ω ∈ {S}^{2}} x ( ka , Ω ) {w}^{*} ( k , Ω ) d Ω = {\sum }_{n = 0}^{∞} {\sum }_{m = - n}^{n} {x}_{nm} ( ka ) {w}_{nm}^{*} ( k ) , \qquad ( 10 )$$

where wₙₘ are the spherical Fourier transform coefficients of w. Note that the summation term in (10) can be viewed as weighting in the spherical harmonics domain, also called phase-mode processing.

In practice, the sound pressure is spatially sampled at the microphone positions Ωₛ, s=1, . . . , M, where M is the number of microphones. We require that the microphone positions fulfil the following discrete orthonormality condition:

$${\sum }_{s = 1}^{M} {α}_{s} {Y}_{{n}^{′}}^{{m}^{′}} ( {Ω}_{s} ) {Y}_{n}^{m *} ( {Ω}_{s} ) = {δ}_{n - {n}^{′}} {δ}_{m - {m}^{′}} , \qquad ( 11 )$$

where αₛ depends on the sampling scheme. For uniform sampling, in order that

$${\sum }_{s = 1}^{M} {α}_{s} = {\int }_{Ω ∈ {S}^{2}} d Ω = 4 π ,$$

we have αₛ≡4π/M. It will be appreciated that alternative spatial sampling schemes for the positioning of microphones on a sphere are equally valid.

Note that with a finite number of microphones sampling the sphere, the spherical harmonic order N is required to satisfy M≧(N+1)² in order to avoid spatial aliasing. In other words, for a given order N, the number of microphones Al must be at least (N+1)².

The discrete spherical Fourier transform (spherical Fourier coefficients) of x(ka,Ωₛ), and the inverse transform, are given by

$$\begin{matrix}{x}_{nm} ( ka ) = {\sum }_{s = 1}^{M} {α}_{s} x ( ka , {Ω}_{s} ) {Y}_{n}^{m *} ( {Ω}_{s} ) , & ( 12 ) \\ x ( ka , {Ω}_{s} ) = {\sum }_{n = 0}^{N} {\sum }_{m = - n}^{n} {x}_{nm} ( ka ) {Y}_{n}^{m} ( {Ω}_{s} ) . & ( 13 )\end{matrix}$$

To simplify the analysis, in this paper, we assume that the spatial sampling by microphones is perfect and that the aliasing is negligible, thus αₛ≡4π/M.

The corresponding array output y(ka) can be calculated by:

$$y ( ka ) = {\sum }_{s = 1}^{M} {α}_{s} x ( ka , {Ω}_{s} ) {w}^{*} ( k , {Ω}_{s} ) = {\sum }_{n = 0}^{N} {\sum }_{m = - n}^{n} {x}_{nm} ( ka ) {w}_{nm}^{*} ( k ) , \qquad ( 14 )$$

where w*(k,Ωₛ) are the array weights and w*ₙₘ(k) are their spherical Fourier coefficients. Note that, in the case of ideal uniform sampling, the array output amplitude in (14) is the factor 4π/M higher than the classical array processing, which is

$${\sum }_{s = 1}^{M} x ( ka , {Ω}_{s} ) {w}^{*} ( k , {Ω}_{s} ) .$$

By using Parseval's relation for the spherical Fourier transform to the weights, we have

$${\sum }_{s = 1}^{M} {α}_{s} {\vert w ( k , {Ω}_{s} ) \vert}^{2} = {\sum }_{n = 0}^{N} {\sum }_{m = - n}^{n} {\vert {w}_{nm} ( k ) \vert}^{2} , \qquad ( 15 )$$

which indicates the factors αₛ.

1. A method of forming a beampattern in a beamformer of the type in which the beamformer receives input signals from a sensor array, decomposes the input signals into the spherical harmonics domain, applies weighting coefficients to the spherical harmonics and combines them to form an output signal, wherein the weighting coefficients are optimized for a given set of input parameters by convex optimization.

2. The method of claim 1, wherein the sensor array is a spherical array in which the sensors positions are located on a notional spherical surface.

3. The method of claim 2, wherein the sensor array is of a form selected from the group of: an open sphere array, a rigid sphere array, a hemisphere array, a dual open sphere array, a spherical shell array, and a single open sphere array with cardioid microphones.

4. The method of claim 1, wherein the array is designed for voice band applications and has a largest dimension of about 8 cm to about 30 cm.

5. The method of claim 1, wherein the sensor array is a microphone array.

6. The method of claim 1, wherein the optimization problem, and optionally also constraints, are formulated as one or more of: minimising the output power of the array, minimising the sidelobe level, minimising the distortion in the mainlobe region and maximising the white noise gain.

7. The method of claim 1, wherein the optimization problem is formulated as minimising the output power of the array.

8. The method of claim 1, wherein the input parameters include a requirement that the array gain in a specified direction be maintained at a given level, so as to form a main lobe in the beampattern.

9. The method of claim 8, wherein the input parameters include requirements that the array gain in a plurality of specified directions be maintained at a given level, so as to form multiple main lobes in the beampattern.

10. The method of claim 9, wherein individual required gain levels are provided for each of the plurality of specified directions, so as to form multiple main lobes of different levels in the beampattern.

11. The method of claim 8, wherein the beamformer formulates the or each requirement as a convex constraint.

12. The method of claim 11, wherein the beamformer formulates the or each requirement as a linear equality constraint.

13. The method of claim 12, wherein the beamformer formulates the or each requirement as a requirement that the array output for a unit magnitude plane wave incident on the array from the specified direction is equal to a predetermined constant.

14. The method of claim 1, wherein the input parameters include a requirement that the array gain in a specified direction is below a given level, so as to form a null in the beampattern.

15. The method of claim 14, wherein the input parameters include requirements that the array gain in a plurality of specified directions is below a given level, so as to form multiple nulls in the beampattern.

16. The method of claim 15, wherein individual maximum gain levels are provided for each of the plurality of specified directions, so as to form multiple nulls of different depths in the beampattern.

17. The method of claim 14, wherein the beamformer formulates the or each requirement as a convex constraint.

18. The method of claim 17, wherein the beamformer formulates the or each requirement as a second order cone constraint.

19. The method of claim 18, wherein the beamformer formulates the or each requirement as a requirement that the magnitude of the array output for a unit magnitude plane wave incident on the array from the specified direction is less than a predetermined constant.

20. The method of claim 1, wherein the input parameters include a requirement that the beampattern has a specified level of robustness.

21. The method of claim 20, wherein the level of robustness is specified as a limitation on a norm of a vector comprising the weighting coefficients.

22. The method of claim 21, wherein the norm is the Euclidean norm.

23. The method of claim 1, wherein the weighting coefficients are optimized by second order cone programming.

24. The method of claim 1, wherein one or more weighting coefficients are optimized for each order n of spherical harmonic, but within each order of spherical harmonics, said weighting coefficients are common to all degrees m=−n to m=n of said order n.

25. The method of claim 1, wherein the input signals are transformed into the frequency domain before being decomposed into the spherical harmonics domain.

26. The method of claim 25, wherein the beamformer is a broadband beamformer in which the frequency domain signals are divided into narrowband frequency bins and wherein each bin is optimized and weighted separately before the frequency bins are recombined into a broadband output.

27. The method of claim 1, wherein the input signals are processed in the time domain and wherein the weighting coefficients are the tap weights of finite impulse response filters applied to the spherical harmonic signals.

28. A beamformer comprising:
an array of sensors, each of which is arranged to generate a signal;
a spherical harmonic decomposer which is arranged to decompose the input signals into the spherical harmonics domain and to output the decomposed signals;
a weighting coefficients calculator which is arranged to calculate weighting coefficients to be applied to the decomposed signals by convex optimization based on a set of input parameters; and
an output generator which combines the decomposed signals with the calculated weighting coefficients into an output signal;_{—}

29. The beamformer of claim 28, further comprising a signal tracker which is arranged to evaluate the signals from the sensors to determine the directions of desired signal sources and the directions of unwanted interference sources.

30. A method of forming a beampattern in a beamformer of the type in which the beamformer receives input signals from a sensor array, applies weighting coefficients to the signals and combines them to form an output signal, wherein the weighting coefficients are optimized for a given set of input parameters by convex optimization, subject to constraints that the array gain in a plurality of specified directions be maintained at a given level, so as to form multiple main lobes in the beampattern, and wherein each requirement is formulated as a requirement that the array output for a unit magnitude plane wave incident on the array from the specified direction is equal to a predetermined constant.

31. A non-transitory computer-readable readable medium storing computer-executable instructions, which when executed on a computer, cause the computer to carry out steps of forming a beampattern in a beamformer of the type in which the beamformer:
receives input signals from a sensor array;
decomposes the input signals into the spherical harmonics domain;
applies weighting coefficients to the spherical harmonics; and
combines the spherical harmonics to form an output signal, wherein the weighting coefficients are optimized for a given set of input parameters by convex optimization.

32. (canceled)

33. (canceled)

34. A method of recording computer-executable instructions on a non-transitory computer-readable readable medium, comprising storing the computer-executable instructions on the computer-readable medium, wherein the computer-executable instruction, when executed by a processor, cause the processor to form a beampattern in a beamformer of the type in which the beamformer:
receives input signals from a sensor array;
decomposes the input signals into the spherical harmonics domain;
applies weighting coefficients to the spherical harmonics; and
combines the spherical harmonics to form an output signal, wherein the weighting coefficients are optimized for a given set of input parameters by convex optimization.

35. A method of providing computer-executable instructions to a remotely located computer-readable readable medium, comprising: ( )transmitting computer-executable instructions to the remotely located computer-readable medium, and (ii) storing the computer-executable instructions on the computer-readable medium, wherein the computer-executable instruction, when executed by a processor, cause the processor to form a beampattern in a beamformer of the type in which the beamformer:
receives input signals from a sensor array;
decomposes the input signals into the spherical harmonics domain;
applies weighting coefficients to the spherical harmonics; and
combines the spherical harmonics to form an output signal, wherein the weighting coefficients are optimized for a given set of input parameters by convex optimization.
